(19) United States
(12) Patent Application Publication
(10) Pub. No.: US 2009/0096661 A1
(43) Pub. Date: Apr. 16, 2009

(54) Method for detecting interference in radar system and radar using the same

(75) Inventor: Mai Sakamoto, Kounan-shi (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/077,674

(22) Filed: Mar. 19, 2008

(30) Foreign Application Priority Data
Mar. 20, 2007 (JP) 2007-072886

(51) Int. Cl. G01S 13/00

(52) U.S. Cl. 342/92

(57) ABSTRACT

A method for a radar for determining a level of interference of return of a radar wave transmitted by the radar from a target object and radio wave transmitted by some other radar, and a radar, in particular a frequency modulated continuous wave (FMCW) radar, that performs the method for determining the level of interference between the radar and some other radar is provided. In the method according to the present invention, after incident radio wave received by the radar is subjected by a frequency analysis to obtain frequency spectrum characteristic of the incident radio wave, one of frequency components of incident radio wave, the one of the frequency components having larger intensity than a predetermined intensity threshold value is not used to calculate a reference value that indicates the level of interference.

### CROSS REFERENCE TO RELATED APPLICATION

The present application relates to and incorporates by reference Japanese Patent Applications 2007-72886 filed on Mar. 20, 2007.

### BACKGROUND OF THE INVENTION

1. The Field of the Invention

The present invention relates to a method for a radar for determining a level of interference between the radar and some other radar. The present invention further relates to an interference detecting device for a frequency modulated continuous wave (FMCW) radar and to the FMCW radar equipped with the interference detecting device using the method for determining the level of interference between the radar and some other radar.

2. Description of the Prior Art

A number of automotive radar systems which are suited to vehicle safety system, for example, crash protection systems that minimize the effects of an accident, reversing warning systems that warn the driver that the vehicle is about to back into an object such as a child or another vehicle and the like, are known. Hence, it is important for these automotive radar systems to provide the driver with some information as to the nature or location of a target object. One target characteristic of great importance is the distance from the radar to the target object (the downrange distance). In particular, if there are multiple target objects, distances to those target objects are important information for the driver. Thus, it is obvious that radars that provide accurate downrange information for multiple target objects are desired.

The simplest automotive radar systems use a continuous wave (CW) radar in which a transmitter continuously transmits electromagnetic energy at a single frequency. The transmitted electromagnetic energy is reflected by a target object and received by the radar receiver. The received signal is shifted due to Doppler's effect by movement of the target object relative to the radar. The CW receiver filters out any returns without a Doppler shift, i.e., targets which are not moving with respect to the radar. When the receiver detects the presence of a Doppler shifted signal, the receiver sends a notification containing information about presence of the target object.

Another type of radar is a two-frequency CW radar. The two-frequency CW radar transmits electromagnetic energy at a first frequency and a second frequency. The transmitted energy is reflected by a target object and received by a two-frequency receiver. The receiver measures the difference between the phase of the signal received at the first frequency and the phase of the signal received at the second frequency. The distance to the target object can be calculated from the measured phase difference. Unfortunately, the two-frequency CW radar performs poorly when there are multiple target objects at different ranges, and thus the range measurement obtained from a two-frequency CW radar in the presence of multiple target objects unreliable.

There have been known FMCW radars used as vehicle-mounted radars to detect the presence of target object or obstacles, distance to a preceding vehicle, and relative speed of the preceding vehicle from the vehicle equipped with the FMCW radar.

In order to detect target characteristic such as presence of a preceding vehicle, downrange distance to the preceding vehicle, and relative speed of the preceding vehicle, the FMCW radar transmits a radar wave via a directional antenna unit. The frequency of the radar wave is modulated so as to linearly vary in time. After the target object reflects the radar wave, the reflected radar wave is received by the radar and transformed into a received signal to be subjected to signal processing for obtaining the target characteristic. The FMCW radar mixes the transmission signal and the received signal to produce a beat signal. The beat signal is subjected to a frequency analysis, for example, a fast Fourier transformation (FFT) and the like, to obtain the peak frequencies of the beat signal (beat frequencies) from which the distance to the target object and the relative speed between the FMCW radar and the target object can be determined. The frequency spectrum has peak intensities in the intensity versus frequency characteristic curves. The beat frequencies have the peak intensities.

During those operations, there is a possibility that the FMCW radar receives not only the reflected wave from the target object, but also a radar wave transmitted from some other radar installed in another vehicle, such as a vehicle running on the same or other side of the road (e.g., a preceding vehicle or an oncoming vehicle). That is, interference between the FMCW radar with which the subject vehicle is equipped and the other radar Installed in the other vehicle may occur. As a result of interference, it is hard to detect the beat frequencies accurately, and the distance to the target object such as the preceding vehicle or the relative speed of the target object cannot be accurately detected.

One of the reasons for difficulties in detecting such target characteristic accurately is that frequency spectrum characteristic of the beat signal contains a broad peak. The broad peak in the frequency spectrum characteristic of the beat signal may be caused by interference which occurs in cases where the FMCW radar and the other radar have different modulation gradients of radar waves from each other (even if only slightly), or where the other radar is not FMCW type, for example, but two-frequency continuous wave, multi-frequency continuous wave, pulse, spread spectrum, and the like. The broad peak in the frequency spectrum characteristic may raise the noise floor level of the frequency spectrum characteristic of the beat signal so that the peak height of peak frequency of the beat signal (beat frequency) generated by mixing of the transmission signal and the received signal does not exceed the noise floor level. In general, the noise floor level is the intensity of the noise from unidentified sources. As a result, the peak frequency cannot be detected accurately for the beat frequency. This results in an inaccurate detection of the target characteristic. That is, the distance to the target object or the relative speed of the target object may be erroneously determined.

In Japanese Published Patent Application No. 2006-2220624 and the corresponding U.S. Patent Application No. 2006/0181448, Natsume et al. discloses an FMCW radar which is capable of determining whether or not the FMCW radar is interfered with by some other radar.

The FMCW radar of Natsume et al. extracts high frequency components larger than a threshold frequency below which the beat frequency corresponding to the target characteristic of a target object located within the measuring rage of the FMCW radar should be positioned from the full frequency components of the beat signal. A high frequency range is defined as a frequency range containing frequency components exceeding the threshold frequency. Intensities of high frequency components of beat signal are used to calculate a reference value which is considered to relate to background noise or noise floor level. Then it is determined whether or not the FMCW radar is interfered with by some other radar based on the calculated reference value. In one of the embodiments of the FMCW radar of Natsume et al., the reference value is a sum (integral) of the intensities of the frequency components over the high frequency range. A determination whether or not interference between the FMCW radar and some other radar occurs is performed based on the sum of the intensities of the high frequency components. In another embodiment of the FMCW radar of Natsume et al., the reference value is a number of frequency components which satisfy predetermined conditions. The predetermined conditions are those that are beyond a predetermined frequency threshold and the intensities of the frequency components exceed a predetermined intensity threshold, wherein the predetermined frequency threshold is set to be out of a range within which the beat frequency corresponding to the target object located in the measuring distance range (the radar range) should be positioned, and the predetermined Intensity threshold is set to be a sufficiently large value which cannot be obtained without occurrence of interference by some other radar. The predetermined frequency threshold can be set to twice the threshold frequency. It is judged whether or not interference between the FMCW radar and some other radar occurs based on the number of frequency components which satisfy the above-mentioned predetermined conditions.

The fundamental fact that is utilized by the conventional FMCW radars including that of Natsume et al. in detection of interference between the FMCW radar and some other radar is that an increase of the noise floor level of the frequency spectrum characteristic of the beat signal increases the sum of intensities of the high frequency components and increases the number of frequency components which satisfy the predetermined conditions. Using this fact, if the sum or the number exceeds corresponding threshold value, the conventional FMCW radars conclude that interference between the FMCW radar and some other radar is present.

However, the sum and the number just mentioned are increased by presence of some large or long obstacle located far beyond the measuring region of the FMCW radar. Such a large or long obstacle produces a beat signal having a higher beat frequency than that corresponding to the target object located in the measuring distance range. In particular, if there are more than a few target objects, a broad peak in the high frequency region of the frequency spectrum characteristic can appear, and may enhance the sum of intensities of the high frequency components or increase the number of the frequency components which satisfy the predetermined conditions beyond the corresponding threshold values. Hence, the conventional FMCW radars using the above mentioned fact may erroneously detect interference due to the existence of large or long obstacles located far beyond the measuring region of the FMCW radar.

Further, if there are some large vehicles such as trucks and lorries, or large and long buildings such as a freeway bridge and its piers, the frequency spectrum characteristic of a beat signal may contain multiple high intensity peaks in the high frequency region.

Thus, large obstacles located far beyond the measuring region of the FMCW radar enhance the sum of intensities of the high frequency components and increase the number of frequency components which satisfy the predetermined conditions even if there are no other radars near, and result in erroneous determination of occurrence of interference between the FMCW radar and some other radar. This means that it is necessary to establish a method for the FMCW radar for accurately detecting noise floor level in order to reliably detect the presence or absence of large target objects located far beyond the measuring region of the FMCW radar. Further, it is necessary to establish a method for FMCW radar for accurately determining whether interference between the FMCW radar and some other radar occurs even if some large or long obstacles such as trucks and lorries, or large and long buildings such as a freeway bridge and its piers exist beyond the measuring region of the FMCW radar.

The first step to solve the above-mentioned problems, it is necessary to establish a method for determining the noise floor level accurately based on incident wave to the receiving antennas of the radar.

In a prior method for a radar system that transmits a radar wave and receives the reflected radar wave from a target object to detect the target characteristic such as the downrange distance between the target object and the radar system for estimating noise floor level of a beat signal generated by mixing the radar wave and the reflected radar wave, a functional value of the maximum power spectrum of the beat signal has been recognized as noise floor level. Komori et al. disclose in WO 2006/120824 a method for determining the noise floor level as a function of the maximum power spectrum of the beat signal. In the method of Komori et al., if any spike noise is detected, the noise floor level of the frequency spectrum characteristic of the beat signal is determined based on the maximum absolute value of the spike noise. In this method, it is necessary to predetermine accurately the relationships between the maximum absolute value of the spike noise and the noise floor level of the frequency spectrum characteristic of the beat signal. This determination may be a difficult task if any interference between the radar and some other radar occurs.

In Japanese Published Patent Application No. 2004-163340 and the corresponding U.S. Patent Application No. 2004/0095269, Uehara et al. disclose a vehicle-mounted radar system that detects reception of interference wave and estimates noise floor level. The radar system disclosed by Uehara et al. comprises a transmitting means for transmitting an electromagnetic wave and a receiving means for receiving the electromagnetic wave reflected by a target object. The radar system of Uehara et al. further comprises a signal processing means for measuring a distance between the radar system and the target object and a relative velocity on the basis of the transmitted electromagnetic wave and the received electromagnetic wave, and an interference detecting means for suspending a transmit operation of the transmitting means under a control of the signal processing means to detect an interference signal from an other external device. With this structure, because only noise signals such as interference wave entering the radar system are measured without measuring the reflected wave of any obstacles, the noise floor level can be calculated according to the definition of the noise floor level. However, it is necessary to suspend the transmit operation to estimate the noise floor level and to detect occurrence of interference. This means that during noise floor level estimation and Interference detection, any target characteristic such as presence of a target object within the measuring distance range of the radar system, distance between the radar system and the target object, and relative velocity of the target object to the radar system can not be determined. This means that a continuous measurement of target characteristic can not performed.

Therefore, it is desired a radar that is capable of determining noise floor level accurately, detecting occurrence of interference between the radar and some other radar reliably, and measuring target characteristic such as presence of a target object within the measuring distance range of the radar system, distance between the radar system and the target object, and relative velocity of the target object to the radar system accurately, even if some large or long obstacles such as trucks and lorries, or large and long buildings such as a freeway bridge and its piers exist beyond the measuring distance range of the radar, and even if there are multiple target objects within the measuring distance range of the radar.

### SUMMARY OF THE INVENTION

The present invention has been made to solve the above-mentioned problems, and therefore an object of the present invention is to provide a method for a radar for determining a level of interference of return of a radar wave transmitted by the radar from a target object and radio wave transmitted by some other radar, and a radar, in particular a frequency modulated continuous wave (FMCW) radar, that performs the method for determining the level of interference between the radar and some other radar.

In the method according to the present invention, after Incident radio wave received by the radar is subjected to a frequency analysis to obtain frequency spectrum characteristic of the incident radio waves, one of the frequency components of incident radio wave, the one of the frequency components having larger intensity than a predetermined intensity threshold value is not used to calculate a reference value that indicates the level of interference. It is preferable that, if a maximum measuring frequency is defined as a frequency equivalent to the farthest distance within measuring distance range of the radar and a range of frequency components exceeding the maximum measuring frequency is referred to as high frequency range, only the frequency components that are within the high frequency range and have intensities smaller than or equal to the predetermined intensity threshold value are used to calculate the reference value, because a large peak appeared within the high frequency range can be attributed to large or long target object such as trucks and lorries, or large and long buildings such as a freeway bridge and its piers exists located out of the measuring distance range of the radar. It is allowed that ones of the intensities larger than the intensity threshold value are corrected to result in a corrected value smaller than or equal to the intensity threshold value. Hence, it is possible to determine the level of interference of return of a radar wave transmitted by the radar from a target object and radio wave transmitted by some other radar due to use of only the ones of frequency components which do not have larger intensity than the predetermined threshold value. If intensity value that is larger than the intensity threshold value is replaced with the corrected value smaller than or equal to the intensity threshold value, all frequency components of the incident radio wave or frequency components within the high frequency range can be used to calculate the reference value.

According to one aspect of the present invention, there is provided a method for detecting an event of interference in which an incident radio wave received by a radar includes a radio wave which has been transmitted by some other radar and superimposed on a return of a radar wave as having been transmitted by a radar.

The method according to this aspect of the present invention includes steps of: performing frequency analysis, identifying an exceptional frequency component, reducing the intensity of the exceptional frequency component, calculating a reference value, and determining whether or not the interference is occurring.

In the step for performing frequency analysis, the electric signal to which the radar converts the incident radio wave is subjected to frequency analysis to obtain a distribution of intensities of frequency components of the electric signal in a frequency domain.

In the step for identifying one of the exceptional frequency component, one of the frequency components which has intensity exceeding a predetermined intensity threshold and which is out of a given frequency range in which the return of the radar wave from a target object within the radar range is to fall is identified as the exceptional frequency component.

In the step for reducing the intensity of the exceptional frequency component, the intensity of the exceptional frequency component is deduced to a corrected intensity which is smaller than or equal to the predetermined intensity threshold to remove influence of an obstacle located out of the radar range on detecting the event of interference.

In the step for calculating a reference value, the reference value is calculated by summing up both the reduced intensity of the exceptional frequency component and the intensities of the frequency components which are other than the exceptional frequency component and are out of the given frequency range.

In the step for determining whether or not the interference is occurring, whether or not the interference is occurring is determined based on the reference value.

According to another aspect of the present invention, there is provided a frequency modulated continuous wave (FMCW) radar that detects a target object characteristic such as presence of a target object within a radar range of the radar, a distance between the target object and the radar, and a relative speed of the target object to the FMCW radar.

The FMCW radar according to this aspect of the present invention includes steps of: a transmission signal generator, a transmission antenna, a reception antenna unit, a beat signal generator, an frequency analyzer, an exceptional frequency component identifying unit, a reducing unit, a reference value calculator, an interference detector, and a target object characteristic calculator.

The transmission signal generator generates a transmission signal whose frequency is modulated so as to have a upward modulated section during which the frequency of the transmission signal increase in time and a downward modulated section during which the frequency of the transmission signal decrease in time.

The transmission antenna transmits the transmission signal as a radar wave in direction of the radar range.

The reception antenna unit receives an incident radio wave received by a radar includes a radio wave which has been transmitted by some other radar and superimposed on a return of a radar wave as having been transmitted by a radar so as to generate a received signal based on the incident radio wave.

The beat signal generator generates a first and second beat signals with respect to each of the upward modulated section and the downward modulated section, respectively, based on both the transmission signal and the received signal.

The frequency analyzer performs frequency analysis on the first and second beat signals to obtain a first frequency spectrum characteristic and a second frequency spectrum characteristic which show distribution of intensities of frequency components of the beat signal in frequency domain with respect to the upward modulated section and the downward modulated section, respectively.

The exceptional frequency component identifying unit identifies at least one of the frequency components a first and a second frequency spectrum characteristics, the one of the frequency components having intensity exceeding a predetermined intensity threshold and which is out of the given frequency range in which the return of the radar wave from a target object within the radar range is to fall as exceptional frequency component.

The reducing unit reduces the intensities of the exceptional frequency component to be smaller than or equal to the predetermined intensity threshold to remove influence of an obstacle located out of the radar range on detecting the event of interference.

The reference value calculator calculates a reference value by summing up both the reduced intensity of the exceptional frequency component and the intensities of the frequency components other than the exceptional frequency component which are other than the exceptional frequency component and are out of the given frequency range.

The interference detector detects whether or not the interference is occurring based on the reference value.

The target object characteristic calculator calculates the target object characteristic based on the first and second peak frequencies.

According to another aspect of the present invention, there is provided a method for determining a noise floor level in analyzing an incident radio wave which is received and translated by a radar into an electric signal and which includes a return of a radar wave as having been transmitted by the radar and reflected from a target object within a measuring distance range of the radar.

The method according to this aspect of the present invention includes steps of: performing frequency analysis, identifying one of the frequency components, reducing the intensity of the exceptional frequency component, calculating a histogram, and determining the noise floor level.

In the step for performing frequency analysis, the electric signal is subjected to frequency analysis to derive a distribution of intensities of frequency components of the electric signal.

In the step for identifying an exceptional frequency component, one of the frequency components which has intensity exceeding a predetermined intensity threshold and which is out of a given frequency range in which the return of the radar wave from a target object within the radar range is to fall is identified as an exceptional frequency component.

In the step for reducing the intensity, the intensity of the exceptional frequency component is reduced to a corrected intensity which is smaller than or equal to the predetermined intensity threshold to give a corrected frequency spectrum characteristic in which the corrected intensity of the exceptional frequency component is used.

In the step for calculating a histogram, the histogram of the intensities of those frequency components which are out of a given frequency range in which the return of the radar wave from the target object is to fall is calculated using the corrected frequency spectrum characteristic of the electric signal.

In the step for determining the noise floor level, one of the intensities having the maximum height in the histogram of the intensities of the frequency components is determined as the noise floor level.

### BRIEF DESCRIPTION OF THE DRAWINGS

The present invention will be understood more fully from the detailed description to be given hereinbelow and from the accompanying drawings of the preferred embodiment of the invention, which is not taken to limit the invention to the specific embodiments but should be recognized for the purpose of explanation and understanding only.

In the drawings:

FIG. 1 is a block diagram showing an FMCW radar according to the present invention;

FIG. 2A is an explanatory graph showing frequency changes over time of a radar wave transmitted from the FMCW radar within an upward modulated section and a downward modulated section and of a reflected radar wave from a target object;

FIG. 2B is an explanatory graph showing the time dependence of the voltage amplitude of a beat signal generated by mixing the radar wave transmitted from the FMCW radar and the reflected radar wave from the target object;

FIG. 2C is an explanatory graph showing a frequency change of the beat signal over time;

FIG. 2D is an explanatory diagram showing beat frequencies within the upward modulated section and the downward modulated section, the beat frequencies being used to determine the distance to the target object and the relative speed of the target object;

FIG. 3A is an explanatory diagram showing frequency changes of the radar wave transmitted from the FMCW radar and of the received radar wave transmitted from some other radar against time, when the frequency spectrum characteristic of the beat signal is affected by interference from some other radar transmitting a radar wave having a different modulation gradient from that of the radar wave transmitted from the FMCW radar;

FIG. 3B is an explanatory diagram showing changes of frequency of the beat signal and of amplitude of voltage of the beat signal over time when the frequency spectrum characteristic of the beat signal are affected by existence of some other radar transmitting the radar wave having a different modulation gradient from that of the radar wave transmitted from the FMCW radar;

FIG. 3C is an explanatory diagram showing electric power spectrum characteristic of the beat signal when the frequency spectrum characteristic of the beat signal is affected by existence of some other radar transmitting the radar wave having a different modulation gradient from that of the radar wave transmitted from the FMCW radar;

FIG. 4A is an explanatory diagram showing the change over time in frequencies of radar wave transmitted from the FMCW radar and a constant frequency of received radar wave transmitted from some other radar when the frequency spectrum characteristic of the beat signal is affected by some other radar transmitting a radar wave having a constant frequency over time;

FIG. 4B is an explanatory diagram showing frequency changes of the beat signal and the voltage amplitude of the beat signal over time when the frequency spectrum characteristic of the beat signal are affected by some other radar transmitting with the constant frequency over time;

FIG. 4C is an explanatory diagram showing the electric power spectrum characteristic of the beat signal when the frequency spectrum characteristic of the beat signal is affected by some other radar transmitting the radar wave having the constant frequency over time;

FIG. 5 is a flow chart showing a process for detecting the target object characteristic, the process including a step of calculating as a reference value an integral value of intensities of ones of frequency components of the beat signal within high frequency range which frequency components have intensities smaller than or equal to a predetermined threshold value;

FIG. 6 is a flow chart showing a process for calculating a reference value according to a first embodiment of the present invention, the process including steps of identifying a peak frequency interval containing one of peak frequency components having a peak intensity larger than the predetermined threshold value in frequency spectrum characteristic of the beat signal, and replacing the peak intensity with an adjusted value smaller than or equal to the intensity threshold value;

FIG. 7 is a graph showing an exemplary power spectrum characteristic of the beat signal in the first embodiment when there are some large target objects located far beyond the measuring distance range of the FMCW radar;

FIG. 8A is a graph showing an exemplary power spectrum characteristic of the beat signal in the first embodiment in which three peak frequency interval containing peak frequency components, f₁, f₂, and f₃ whose intensities (peak intensities) are larger than the predetermined threshold value are seen within the high frequency range;

FIG. 8B is a graph showing a process according to the first embodiment for setting three peak frequency intervals that have the centers of peak frequency intervals at three peak frequency components, f₁, f₂, and f₃, respectively, and have the same width f_{w};

FIG. 9 is a graph showing a process according to the first embodiment for replacing the intensities of three peak frequency intervals containing three peak frequency components, f₁, f₂, and f₃ with adjusted values that is average values of intensities of the lowest and highest frequency components in the respective peak frequency intervals;

FIG. 10 is a flow chart showing a process for detecting the target object according to a comparative art;

FIG. 11 is a graph showing an exemplary frequency spectrum characteristic of the beat signal when interference occurs between the FMCW radar and some other radar, the frequency spectrum characteristic of the beat signal having a high frequency range in which there is no influence from the target object located within the measuring distance range of the FMCW radar and a target-detecting frequency range in which there is some effect from a target object located within the measuring distance range of the FMCW radar;

FIG. 12 is a graph showing an exemplary frequency spectrum characteristic of the beat signal in the high frequency range when interference between the FMCW radar and some other radar occurs;

FIG. 13 is a graph showing an exemplary frequency spectrum characteristic of the beat signal in the high frequency range when no interference between the FMCW radar and some other radar occurs and no large target objects located far beyond the measuring region of the FMCW radar exist;

FIG. 14 is a graph showing an exemplary frequency spectrum characteristic of the beat signal in the high frequency range when no interference between the FMCW radar and some other radar occurs and there are some large target objects located far beyond the measuring region of the FMCW radar;

FIG. 15 is a graph showing a process according to a first modification of the first embodiment for replacing the intensities of three peak frequency intervals containing three peak frequency components, f₁, f₂, and f₃ with adjusted values that is values of intensities of the lowest frequency component in the respective peak frequency intervals;

FIG. 16 is a graph showing a process according to a second modification of the first embodiment for replacing the intensities of three peak frequency intervals containing three peak frequency components, f₁, f₂, and f₃ with adjusted values that is values of intensities of the highest frequency component in the respective peak frequency intervals;

FIG. 17 is a flow chart showing a process for calculating a reference value according to a second embodiment of the present invention, the process including steps of identifying a peak frequency interval containing one of peak frequency components having a peak intensity larger than the predetermined threshold value in frequency spectrum characteristic of the beat signal, and replacing the peak intensity with zero level in the intensity;

FIG. 18 is a flow chart showing a process for calculating the integral value according to a third embodiment of the present invention, the process including steps of identifying a peak frequency interval containing one of the frequency components having intensity larger than the predetermined threshold value in frequency spectrum characteristic of the beat signal, and replacing the peak intensity with zero level in the intensity;

FIG. 19A is a graph showing an exemplary frequency spectrum characteristic of the beat signal in the high frequency range when there are some large target objects located far beyond the measuring region of the FMCW radar;

FIG. 19B is a graph showing a process according to the third embodiment for replacing the intensities of three peak frequency intervals containing three peak frequency components with zero level in intensity;

FIG. 20 is a flow chart showing a process for calculating the integral value according to a fourth embodiment of the present invention, the process including steps of identifying a peak frequency interval containing one of the frequency components having intensity larger than the predetermined threshold value in frequency spectrum characteristic of the beat signal, and replacing the peak intensity with the predetermined threshold value;

FIG. 21 is a graph showing a process according to the fourth embodiment for replacing the intensities of three peak frequency intervals containing three peak frequency components with the predetermined threshold value;

FIG. 22 is a flow chart showing a process according to the fifth embodiment for calculating a noise floor level of the beat signal, the process including a step of calculating a histogram of the intensities of the frequency components in the high frequency range; and

FIG. 23 is a flow chart showing a process according to the fifth embodiment calculating a histogram of the intensities of the frequency components in the high frequency range, the process including steps of: identifying a peak frequency interval containing one of peak frequency components having a peak intensity larger than the predetermined threshold value in frequency spectrum characteristic of the beat signal, and replacing the peak intensity with an adjusted value smaller than or equal to the intensity threshold value.

### DETAILED DESCRIPTION OF PREFERRED EMBODIMENTS

Preferred embodiments of the present invention will be explained below with reference to attached drawings. Identical constituents are denoted by the same reference numerals throughout the drawings.

### First Embodiment

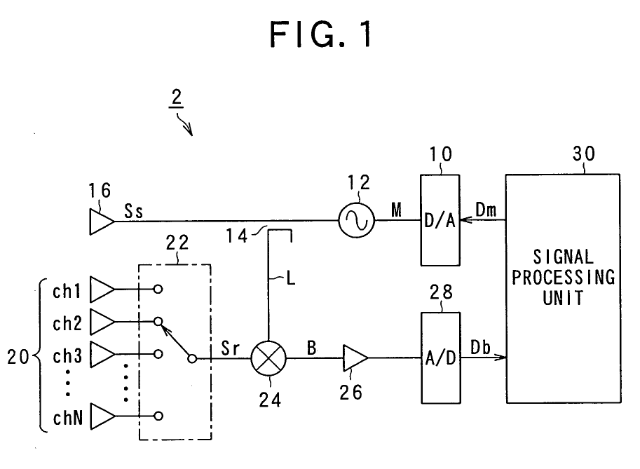

Referring to FIGS. 1-16, a first embodiment and its modifications of the present invention will be discussed.

FIG. 1 is a block diagram showing a vehicle-mounted FMCW radar according to the present invention. The FMCW radar detects the distance to a target object located in a radar range (hereinafter it sometimes will be referred as to a “measuring distance range”) and/or a relative speed of the target object such as a preceding vehicle.

As shown in FIG. 1, the FMCW radar 2 includes a digital-analog (D/A) converter 10, an oscillator 12, a splitter 14, a transmitting antenna 16, and a signal processing unit 30.

The D/A converter 10 receives digital data Dm from the signal processing unit 30 and converts the received digital data Dm to an analog signal M. The oscillator 12 receives the analog signal M from the D/A converter 10 and thereby generates a radio frequency signal in the millimeter wave band, the frequency of the signal varying in time according to information contained in the analog signal M. The splitter 14 splits the electric power of the radio frequency signal generated by the oscillator 12 into a first portion relating to a transmission signal Ss, which is the radio frequency signal in the millimeter wave band, and a second portion relating to a local signal L that will be used to generate a beat signal. The transmitting antenna 16 radiates the transmission signal Ss as a radar wave toward a measuring distance range where a target object may be located.

The analog signal M is modulated by the D/A converter 10 to be formed in a triangular waveform having a period of 2×ΔT where ΔT is called the sweep time. The frequency of the radio frequency signal generated by the oscillator 12 is modulated so as to increase linearly with the sweep time ΔT, and then be linearly decreased within the sweep time ΔT, according to the analog signal M. So the time dependence of the frequency of the transmission signal Ss has the same form with that of the local signal L. In the following, the time period during which the frequency of the radio frequency signal is linearly increased is called the upward modulated section or upsweeping modulation section, and the time period during which the frequency of the radio frequency signal is linearly decreased is called the downward modulated section or downsweeping modulation section.

The FMCW radar 2 further includes a receiving antenna unit 20, an antenna switch 22, a mixer 24, an amplifier 26, and an analog-digital (A/D) converter 28.

The receiving antenna unit 20 is constructed of N receiving antennas that receives a reflected radar wave reflected by the target object located in the measuring distance range. It is preferable that the N receiving antennas are arranged are aligned in a line and evenly spaced. This arrangement will be useful to detect the direction of the target object. Each of the receiving antennas connects to the corresponding receiving channel of the receiving switch 22. The antenna switch 22 selects one of the N receiving antennas constituting the receiving antenna unit 20, and supplies a received signal Sr from the selected receiving antenna to the downstream stage. The antenna switch 22 is connected to the signal processing unit 30. The signal processing unit 30 controls the timing of change for selecting the working antenna among the N receiving antennas of the receiving antenna unit 20. The mixer 24 mixes the received signal Sr supplied from the antenna switch 22 and the local signal L inputted from the splitter 14 to produce a beat signal B. The amplifier 26 amplifies the beat signal produced by the mixer 24 based on the received signal Sr and the local signal L. The amplified beat signal generated by the amplifier 26 is inputted into the A/D converter 28 to convert into digital data Db using a technique for digitizing the amplified beat signal, for example, by sampling the magnitude of the amplified beat signal at a predetermined sampling frequency. In order to generate a sampled signal with a sampling period corresponding to the predetermined sampling frequency, the A/D converter 28 further comprises a timer which is synchronized with a clock of the signal processing unit 30. The signal processing unit 30 receives the digital data Db from the A/D converter 28 and performs signal processing on the digital data Db to obtain information about the target characteristic such as the downrange distance to the target object that reflects the radar wave and the relative speed between the subject vehicle equipped with the FMCW radar 12 and the target object.

The signal processing unit 30 is mainly composed of a central processing unit (CPU), a memory such as a read only memory (ROM) and a random access memory (RAM), and a digital signal processor which is configured to execute a fast Fourier transformation (FFT) in signal processing of the digital data Db. The signal processing unit 30 further includes a clock that controls operation speed of the CPU and the digital signal processor and is used to measure time. The signal processing unit 30 connects to the antenna switch 22 and the A/D converter 28 to control the timing of change for selecting the working antenna and to convert the beat signal B to the digital data Db, respectively.

The N receiving antennas of the receiving antenna unit 20 are assigned to channel 1 (ch1) to channel N (chN), respectively. Let the sampling frequency per channel be fs, the predetermined sampling frequency of the A/D converter 28 should be Fₛₐₘₚ=N×fs.

The sampling frequency per channel fs is set as follows: if the maximum measurement frequency is defined as the frequency of a beat signal B corresponding to the farthest distance within the measuring distance range of the FMCW radar 2, the maximum measurement frequency limits a measuring frequency range such that frequencies below the maximum measurement frequency may be used to detect the distance to the target object that reflects the radar wave and the relative speed between the subject vehicle equipped with the FMCW radar 12 and the target object. Hence, the sampling frequency per channel fs is set to be twice the maximum measurement frequency or larger, preferably quadruple the maximum measurement frequency or larger. This means that the A/D converter 28 executes oversampling to extract redundant information from the beat signal B.

In the FMCW radar 2 constructed by the above-mentioned manner, the analog signal M is produced by the D/A converter 10 according to the digital data Dm from the signal processing unit 30. The frequency of the analog signal M varies in time. Then, the oscillator 12 generates the radio frequency signal in the millimeter wave band. The frequency of the radio frequency signal varies with time in the same way as the frequency of the analog signal M varies. The radio frequency signal generated by the oscillator 12 is split by the splitter 14 to generate the transmission signal Ss and the local signal L. The antenna 16 radiates the transmission signal Ss as the radar wave toward the measuring distance range.

The radar wave radiated from the antenna 16 of the FMCW radar 2 is reflected by a target object such as a preceding vehicle or an oncoming vehicle located in the measuring distance range. The reflected radar wave coming back to the FMCW radar 2 is received by all N receiving antennas of the receiving antenna unit 20. However, the receiving antenna unit 20 receives electromagnetic wave that is transmitted from some other radar or is reflected by some obstacle located out of the measuring distance range of the FMCW radar 2. These electromagnetic waves which are not expected to detect the target object located in the measuring distance range are identified as noise signals.

The N receiving antennas are indexed by channel i (ch i) (i=1, 2, . . . , N). The antenna switch 22 successively selects one of the N receiving antennas such that the channel selected by the antenna switch 22 is changed at a predetermined interval, and supplies the received signal Sr which is received by the antenna connecting to the selected channel of the receiving switch 22 to the mixer 24. It is preferable that the antenna switch 22 includes a timer to change the selected antenna at the predetermined interval. Further it is allowed that the antenna switch 22 connects to the signal processing unit 30 and receives timing signals to change channel. The mixer 24 mixes the received signal Sr supplied from the antenna switch 22 and the local signal L inputted from the splitter 14 to produce the beat signal B. The beat signal B is amplified by the amplifier 26, and then is inputted into the A/D converter 28 to convert into a digital data Db using a technique of digitizing the amplified beat signal. The signal processing unit 30 receives the digital data Db from the A/D converter 28 and performs signal processing on the digital data Db to obtain information about the target characteristic such as the downrange distance to the target object that reflects the radar wave and the relative speed between the subject vehicle equipped with the FMCW radar 12 and the target object.

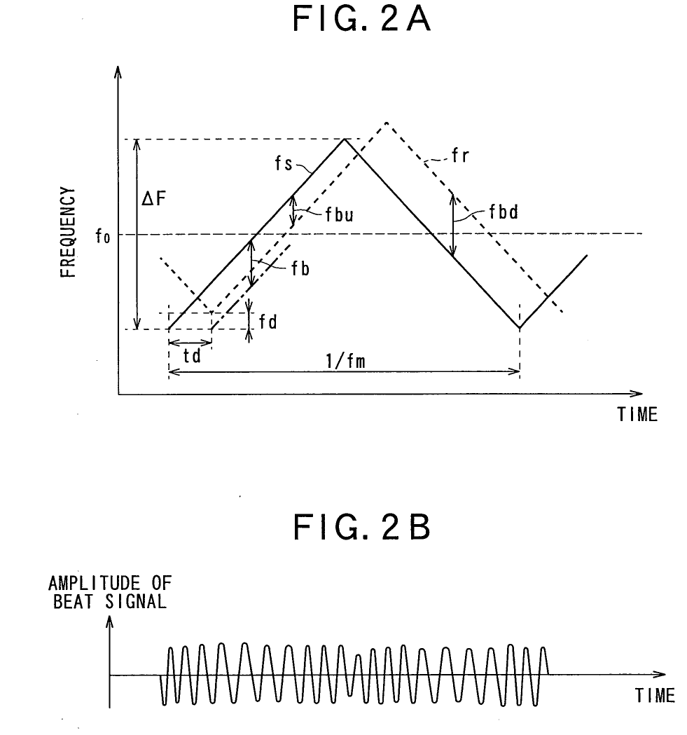

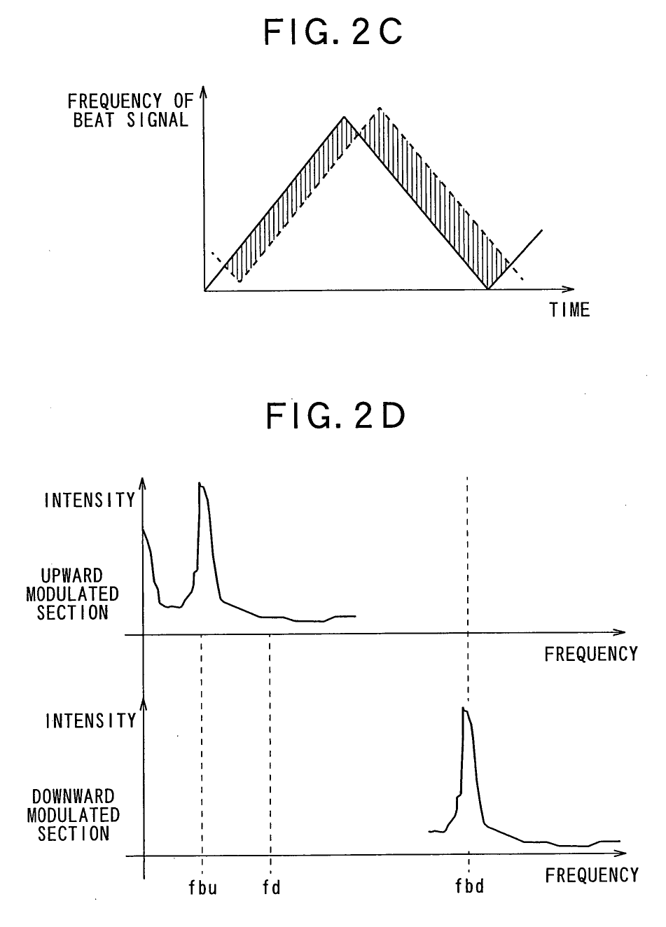

Referring to FIGS. 2A to 2D, a method for detecting the target characteristic such as the distance to the target object that reflects the radar wave and the relative speed between the subject vehicle equipped with the FMCW radar 2 and the target object will be described.

As shown in FIG. 2A, the frequency of the radar wave fs which corresponds to the transmission signal Ss and is transmitted from the antenna 16, varies periodically as a saw-toothed wavefrom. The saw-toothed waveform of the frequency variation of the radar wave fs has the upward modulated section or upsweeping modulation section during which the frequency of the radar wave fs is linearly increased by the frequency modulation width ΔF during the sweep time ΔT equal to half of the width of the frequency variation of the radar wave fs, 1/fₘ, and the downward modulated section or the downsweeping modulation section during which the frequency of the radar wave fs is linearly decreased by the frequency modulation width ΔF during the sweep time ΔT equal to the half of the period of the frequency variation of the radar wave fs, 1/fₘ. Hence, one period of the frequency variation of the radar wave fs of 2×ΔT consists of one upward modulated section and the following downward modulated section. The central frequency of the radar wave fs is f0, as shown in FIG. 2A, which is used to calculate the distance between the device 2 and the target object and the relative speed of the target object. The central frequency f0 of the radar wave fs can be adjusted. The radar wave fs radiated from the antenna 16 of the FMCW radar 2 is reflected by the target object located within the measuring distance range. Then, the target object serves as a source of a reflected radar wave fr, and the reflected radar wave fr is received by the receiving antenna unit 20 to generate the received signal Sr. Both the received signal Sr supplied from the antenna switch 22 and the local signal L inputted from the splitter 14 are mixed by the mixer 24 to produce a beat signal B. Here, the beat signal B includes a mixed signal generated by the local signal L and the received signal Sr within the upward modulated section and a further mixed signal generated by the local signal L and the received signal Sr within the downward modulated section.

For example, the antenna switch 22 is designed to execute the following operation: the antenna switch 22 sequentially changes the selected channel of the antenna unit 20 from channel 1 (ch1) to channel N (chN) each time a timing signal is received from the signal processing unit 30, and repeatedly selects them. Let the number of times of sampling per channel and per one period of the frequency variation of the radar wave fs including the upward modulated section and the downward modulated section, i.e., sweep time 2×ΔT=2×1/fₘ, be 2×Mₛₐₘₚ.

Thus, when a measurement equivalent to one of the upward modulated section and the downward modulated section is completed, Mₛₐₘₚ, pieces of sampled data are produced with respect to each of the channels ch1 to chN.

FIG. 2B is an explanatory time chart showing the voltage amplitude of the beat signal generated by mixer 24. If no interference occurs and no large or long obstacles are located beyond the measuring distance range of the FMCW radar 2, and there are only target objects having zero relative speed to the radar 2 within the measuring distance range, the beat signal has a sinusoidal waveform having a constant frequency.

As shown in FIGS. 2A and 2C, in each of the upward modulated section and the downward modulated section, the A/D converter 28 samples the beat signal B recursively at a predetermined sampling period and converts the sampled beat signal B to the digital signal Db. Thus, the frequency variation of the reflected radar wave fr which includes a frequency increasing period and a frequency decreasing period is generated.

For example, in the case where the velocity of the vehicle-mounted FMCW radar 2 is equal to the velocity of the target object, that is, in the case where the relative speed of the target object is zero, the reflected radar wave is retarded by the time which it takes for the radar wave to travel between the radar 2 and the target object at the velocity of light c. In this case, the reflected radar wave from the target object fr is shifted in time by a retarded time td relative to the radar wave fs, as shown in FIG. 2A. Further, the beat signal B is analyzed by the Fourier analysis or other frequency analytical tool to obtain the power spectrum characteristic or other frequency spectrum characteristic of the beat signal B.

FIG. 2D is an explanatory diagram showing beat frequencies within the upward modulated section and the downward modulated section.

In the currently considered case where the relative speed of the target object is zero, the peak frequency fbu of the beat signal in the frequency increasing period is equal to the peak frequency fbd of the beat signal in the frequency decreasing period. Let a distance between the radar 2 and the target object be D, the distance D is easily obtained by multiplying the velocity of light c by the retarded time td as: D=td×c.

However, in the case where the velocity of the vehicle-mounted FMCW radar 2 is different from the velocity of the target object, that is, in the case where the relative speed of the target object is not zero, the reflected radar wave has Doppler shift fd. Hence, the frequency of the reflected radar wave fr is shifted in frequency by the Doppler shift fd as well as in time by the retarded time td. In this case, as shown in FIG. 2D, the peak frequency fbu of the beat signal in the frequency increasing period is different from the peak frequency fbd of the beat signal in the frequency decreasing period. That is, the frequency of the reflected radar wave fr is shifted in time by the retarded time td as well as in frequency by the Doppler shift fd. Let the relative speed of the target object be V, the relative speed of the target object V can be calculated from the frequency difference between the radar wave fs and the reflected radar wave fr in the frequency axis in FIG. 2A.

The retarded time td of the reflected radar wave fr from the radar wave fs corresponds to a first component fb of the frequency shift of the reflected radar wave fr from the radar wave fr such that:

$$fb = \frac{\vert fbu \vert + \vert fbd \vert}{2} , \qquad ( 1 )$$

where fbu and fbd are the peak frequency of the beat signal in the frequency increasing period and the peak frequency of the beat signal in the frequency decreasing period, respectively. Because, the first component fb in equation (1) is obtained by removing the effect due to the Doppler shift, the first component fb of the frequency shift corresponds to the distance D between the apparatus 2 and the target object, as in the following:

$$D = \frac{c}{4 \times Δ F \times {f}_{m}} \times fb , \qquad ( 2 )$$

where ΔF is the frequency modulation width during half of the period of the frequency variation of the radar wave fs, 1/fₙᵢ, c is the velocity of light.

The Doppler shift fd relating to the relative speed V of the target object can be expressed using the peak frequency fbu of the beat signal in the frequency increasing period and the peak frequency fbd of the beat signal in the frequency decreasing period, as follows:

$$fb = \frac{\vert fbd \vert + \vert fbu \vert}{2} . \qquad ( 3 )$$

The relative speed V of the target object can be obtained from the peak frequencies fbu and fbd, using the following expression:

$$V = \frac{c}{2 \times f 0} \times fd , \qquad ( 4 )$$

where f0 is the central frequency of the radar wave fs.

Hence, using the peak frequency fbu of the beat signal in the frequency increasing period and the peak frequency fbd of the beat signal in the frequency decreasing section, it is possible to obtain the distance between the FMCW radar 2 and the target object and the relative speed of the target object to the FMCW radar 2. Therefore, the determination of the peak frequencies fbu and fbd in the beat signal B is one of the important subjects in the frequency analysis. In order to determine the peak frequencies fbu and fbd accurately, separation of noise components in the frequency spectrum characteristic of the beat signal which directly relate to neither the distance between the target object and the radar 2 nor the relative speed of the target object is important. The noise components in the frequency spectrum characteristic of the beat signal may be generated due to interference which occurs in cases where the FMCW radar with which the subject vehicle is equipped and the other radar Installed in another, interfering vehicle has different modulation gradients of radar waves from each other even if only slightly, or where the other radar is not of FMCW. Those, noise components in the frequency spectrum characteristic of the beat signal lead to raise the noise floor level so that the heights at the peak frequencies fbu and fbd might not exceed the noise floor level. In general, the noise floor level is defined as the lowest threshold of useful signal level. Hence, the noise floor level is the intensity of the weak noise whose source is not specified, and affected by interference between the FMCW radar and some other radar, if interference occurs. Further, conventional tools for determining whether interference is present between the FMCW radar and some other radar gives an erroneous conclusion due to the existence of large target objects located far beyond the measuring region. Thus, it is important to detect large target objects located far beyond the measuring region of the FMCW radar 2.

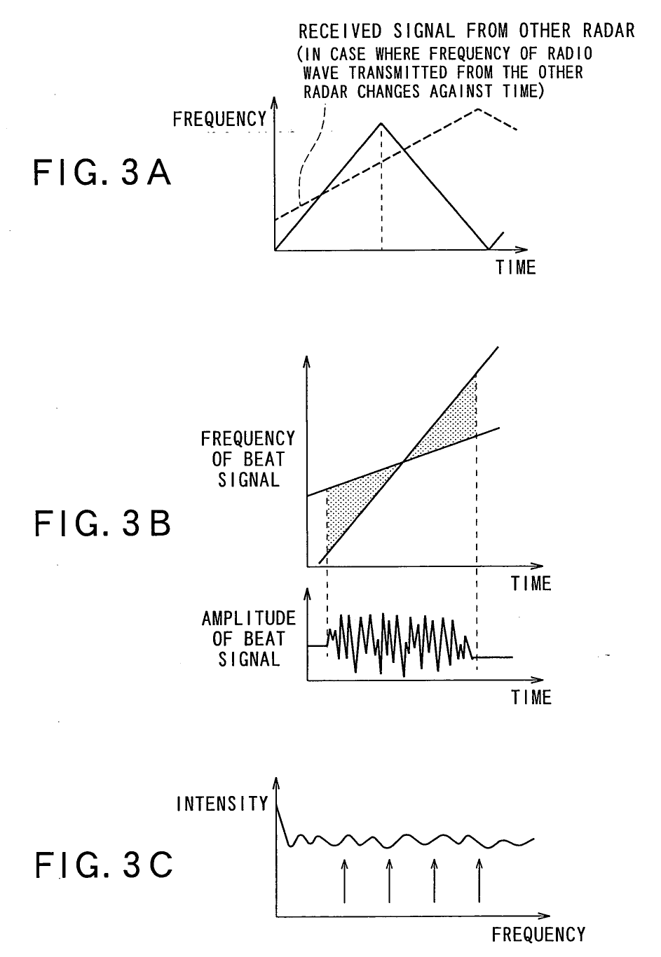

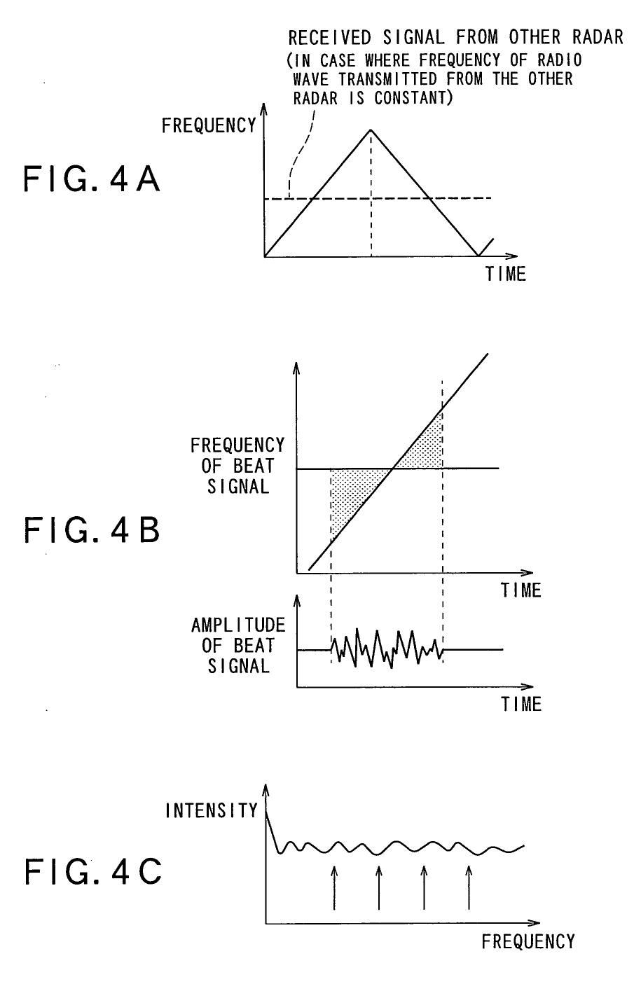

Referring to FIGS. 3A to 4C, more detailed explanations for how the noise floor level increases in several situations such as where the FMCW radar with which the subject vehicle is equipped and the other radar installed in the other (interfering) vehicle has different modulation gradients of radar waves from each other even if the only slightly, and where the other radar is not of FMCW, for example, two-frequency continuous wave, multi-frequency continuous wave, pulse, spread spectrum, and the like will be explained.

FIG. 3A is an explanatory diagram showing changes in time of frequencies of radar wave transmitted from the FMCW radar 2 and of received radar wave transmitted from some other radar transmitting radar waves having a different modulation gradient from that of the radar wave transmitted from the FMCW radar. In this case, the range of the frequency variation of the radar wave fs within the upward modulated section and the downward modulated section overlaps with the range of the frequency variation of the radar waves transmitted simultaneously from the other radar in a time period.

FIG. 3B is an explanatory diagram showing changes of frequency of the beat signal B and of amplitude of voltage of the beat signal B over time. As shown in FIG. 3B, within the upward modulated section, the frequency difference between the local signal L0 and a received radar wave including the radar wave transmitted from the other radar is variable and varies greatly in contrast to the case shown in FIG. 2A. The beat signal is generated by mixing the local signal L0 and the received signal Sr.

If the other radar transmits radar waves having the same frequency variation pattern with the radar wave transmitted from the FMCW radar 2, that is, if the frequency of the radar wave transmitted from the other radar increases within the upward modulated section of the radar wave and decreases within the downward modulated section, a narrow peak appears in the frequency spectrum characteristic in the beat signal.

However, if the frequency gradient of the radar wave transmitted by the other radar is different from that of the radar wave transmitted from the FMCW radar 2, a broad peak will be caused in the frequency spectrum characteristic of the beat signal because the difference between the frequencies of the radar waves transmitted from the other radar and the FMCW radar 2 varies in time so that many components of the frequency spectrum are included in the frequency spectrum characteristic of the beat signal.

FIG. 3C is an explanatory diagram showing the electric power spectrum characteristic of the beat signal in this case. It can be seen that the noise floor level is increased by the interference between the FMCW radar 2 and the other radar that transmits the radar wave having the different modulation gradient from that of the radar wave transmitted from the FMCW radar 2.

FIG. 4A is an explanatory diagram showing the change over time in frequencies of radar wave transmitted from the FMCW radar 2 and a constant frequency of received radar wave transmitted from some other radar. The radars that transmit a radar wave having a constant frequency may include a two-frequency continuous wave type radar, a multi-frequency continuous wave type radar, a pulse type radar, and a spectrum spreading type radar.

FIG. 4B is an explanatory diagram showing changes of frequency of the beat signal and of amplitude of voltage of the beat signal in time. In the case shown in FIG. 4B, within both the upward modulated section and the downward modulated section, the frequency difference between the local signal L0 and the received radar wave including the radar wave transmitted from the other radar is not constant and varies greatly in contrast to the case shown in FIG. 2A.

In this case, as shown in FIG. 4C, the noise floor level is increased by the interference between the FMCW radar 2 and the other radar that transmits the radar wave having the different modulation gradient from that of the radar wave transmitted from the FMCW radar 2.

In both cases shown in FIGS. 3A and 4A, the beat signal includes frequency components from a low frequency to a high frequency, because the frequency difference between the local signal L0 and the received radar wave including the radar wave transmitted from the other radar is not constant and varies greatly. Therefore, when interference is caused between the radar waves transmitted from the FMCW radar 2 and the other radar, the frequency spectrum characteristic obtained by a frequency analysis may include a broad peak or enhanced noise floor level. If we define the maximum measurement frequency as a frequency below which the beat frequency corresponding to the target characteristic of the target object located within a measuring distance range of the FMCW radar, some frequency components of the broad peak are beyond the maximum measurement frequency.

The broad peak generated by interference by some other radar is detected by using one of known techniques utilizing the fact that a rise in the noise floor level of the frequency spectrum characteristic of the beat signal leads to an increase in the sum of intensities of the high frequency components or the count of frequency components which satisfy the predetermined conditions. Using this fact, if the sum or the count exceeds a corresponding threshold value, the conventional FMCW radars conclude that interference by some other radar occurs.

If some large vehicles such as trucks and lorries, or buildings such as a freeway bridge and its piers are at a place further than the measuring distance range of the FMCW radar 2, the frequency spectrum characteristic of a beat signal may contain multiple very large peaks in the high frequency region beyond the maximum measurement frequency. Thus, large target objects located far beyond the measuring region of the FMCW radar increase the sum of intensities of the high frequency components and the count of frequency components which satisfy the predetermined conditions without any other radar, and result in erroneous determinations of interference by some other radar when one of the known techniques is applied.

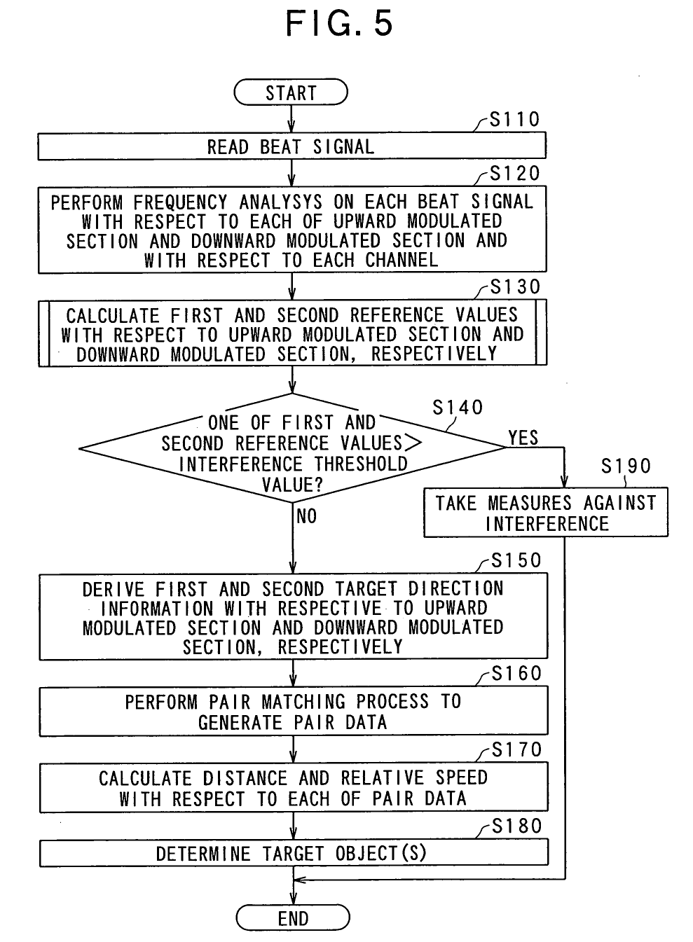

Hereinafter, referring to FIG. 5, a method for determining whether interference by some other radar occurs will be explained. The method to be explained below results in improving accuracy of determining whether interference by some other radar occurs.

FIG. 5 is a flow chart showing a method for determining whether interference by some other radar occurs. The method works well even if large target objects, for example, large vehicles such as trucks and lorries, or buildings such as a freeway bridge and its piers are at a place further than the measuring distance range of the FMCW radar 2. The method includes a step of detecting the noise floor level of the frequency spectrum characteristic of the beat signal based on a histogram of the intensities of the frequency components of the beat signal. The processes shown in FIG. 5 are carried out by the signal processing unit 30 in FIG. 1. This procedure starts and then repeats with a predetermined interval.

At step S110, the signal processing unit 30 outputs digital data Dm to the D/A converter 10. The digital data Dm includes information about frequency modulation of the radio frequency signal in the millimeter wave band to generate the radar wave over one period of the frequency variation. One period of the frequency variation consists of the upward modulated section and the downward modulated section. In the upward modulated section, the frequency of the radar wave fs is linearly increased by the frequency modulation width ΔF during the sweep time ΔT. In the downward modulated section, the frequency of the radar wave fs is linearly decreased by the frequency modulation width ΔF during the sweep time ΔT. The information for modulating the radio frequency signal is used by the oscillator 12 to generate the radar wave to be radiated from the antenna 16. Moreover, at step S110, the signal processing unit 30 reads digital data Db obtained by the A/D converter 28. The digital data Db is obtained by converting the beat signal generated by the mixer 24. The beat signal is generated by mixing the received signal Sr, i.e., the reflected radar wave received by the receiving antenna unit 20, and the local signal L that includes information about the digital data Dm.

In this embodiment, the digital data Db of the beat signal B consists of first digital data including intensity of the beat signal in the frequency increasing section and second digital data including intensity of the beat signal in the frequency decreasing section. The digital data Db of the beat signal B is stored in the memory of the signal processing unit 30. Each of the first and second digital data has N×Mₛₐₘₚ pieces of sampled data. Thus, the A/D converter 28 executes oversampling to extract redundant information from the beat signal.

Subsequently at step S120, the signal processing unit 30 executes the frequency analysis, for example the fast Fourier transformation (FFT) analysis, for the first and second digital data of the beat signal corresponding to data in the frequency increasing section and in the frequency decreasing section, respectively. As a result of the fast Fourier transformation, complex values, each value being assigned to the one of the frequency components, are calculated. That is, a time domain representation of intensity of the beat signal is transformed to a frequency domain representation thereof by means of the Fourier transformation. The absolute value of each of complex values indicates the power of the corresponding frequency component. Thus, by means of the Fourier transformation, the power spectrum of the beat signal or the frequency spectrum characteristic can be obtained.

It is allowed that the first and second frequency spectrum characteristics of the beat signal corresponding to the first and second digital data, respectively, would be separately calculated. Further, it is allowed that each frequency spectrum characteristic of the beat signal with respect to each channel and each of the frequency increasing section and the frequency decreasing section would be calculated based on each Mₛₐₘₚ pieces of sampled data. In this case, two spectrum characteristic of the beat signal B are obtained.

It is noted that if the maximum measurement frequency is defined as a frequency of a beat signal B which indicates the farthest distance within the measuring distance range of the FMCW radar 2, i.e., a radar range, the maximum measurement frequency limits a measuring frequency range such that frequency components below the maximum measurement frequency are allowed to detect the distance to the target object that reflects the radar wave and the relative speed between the subject vehicle equipped with the FMCW radar 12 and the target object. Thus, high frequency components can be defined as those beyond the maximum measurement frequency. The frequency range covering the high frequency components will be referred as to the high frequency range.

The power spectrums of the beat signal or the frequency spectrum characteristics with respect to each of the frequency increasing section and the frequency decreasing section contain not only frequency components lower than or equal to the maximum measurement frequency, which will be referred as to a target-detecting frequency range, but also frequency components exceeding the maximum measurement frequency, i.e., within the high frequency range.

If the maximum measurement frequency is set to 116 kilohertz which corresponds to 256 meters when the relative speed of the target object is zero, the high frequency range can be set to be 200 to 333 kilohertz.

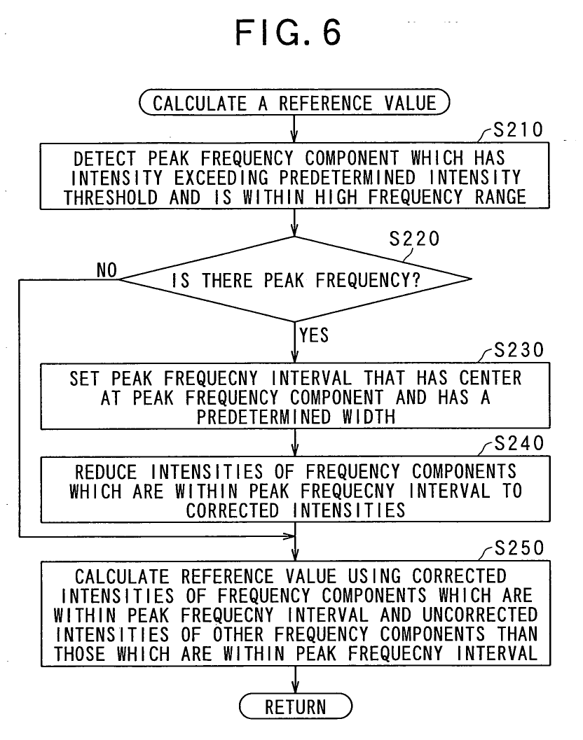

At step S130, using the power spectrums of the beat signal obtained at step S120, especially using the power spectrum data corresponding to the frequency components within the high frequency range, a first and a second reference values with respect to the frequency increasing section and the frequency decreasing section, respectively, are calculated. More detailed description about operations in this step will be discussed, below referring to FIG. 6.

Here, it should be mentioned that the first and the second reference values are obtained by integrating the intensities of the frequency components of the beat signal over a given frequency range, and indicate the level of interference between the FMCW radar 2 and some other radar with respect to the frequency increasing section and the frequency decreasing section, respectively. The higher the level of interference becomes, the larger fraction of radio wave transmitted from the other radar to the incident radio wave received by the FMCW radar 2 is indicated.

It is noticed that, if a return of the radar wave from obstacles located out of the measuring distance region can be removed, an integral value of intensities of the frequency components over the high frequency range can determines a noise floor level of the beat signal. Thus, the first and the second reference values can be recognized as indicative of the noise floor level with respect to the frequency increasing section and the frequency decreasing section, respectively.

It is allowed that only one reference value is obtained instead of the case where the first and the second reference values are obtained. In this case, the one reference value is calculated using either one of the two spectrum characteristic of the beat signal B generated at step S120 or both of the two spectrum characteristic of the beat signal B. For example, the first and the second reference values are averaged to give the one reference value.

Then, at step S140, the signal processing unit 30 compares the first and second reference values with a predetermined interference threshold value. That is, it is determined whether or not at least one of the first and second reference values exceeds the predetermined interference threshold value. If a result of the determination at the step S140 is “YES”, it is determined that interference between the FMCW radar 2 and some other radar occurs. Then, the procedure proceeds to step S190.

In contrast to this, that is, a result of the determination at the step S140 is “NO”, it is determined that no interference between the FMCW radar 2 and some other radar occurs. Then, the procedure proceeds to step S150.

If only one reference value was obtained in the step S130, it is determined whether or not the integral value exceeds the predetermined interference threshold value.

At step S150, a peak-detecting threshold value is set to be larger than the predetermined interference threshold value, and frequency components which are below the maximum measurement frequency and whose power exceed the peak-detecting threshold value are separately collected as peak frequencies with respect to each of the upward modulated section and the downward modulated section and with respect to each channel. Then, the digital data xᵢ(t) (i=1, . . . , N) corresponding to each of the peak frequencies with respect to corresponding channel are collected from the received signal Sr to form a vector X(t)=(xᵢ(t), . . . , x_{N}(t)). It is preferable that each of the digital data xᵢ(t) (i=1, . . . , N) consists of data in 3 upward modulated sections or 3 downward modulated sections. This vector X(t) is utilized to obtain the direction of the target object located within the measuring distance range of the FMCW radar 2. For example, the multiple signal classification (MUSIC) method can be applied to obtain the direction of the target object, if the N antennas of the receiving antenna unit 20 are equally separated. In the MUSIC method, a self-correlation matrix of X(t) plays a central role to estimate the direction of the target object. A description of the MUSIC method can be found in “Multiple emitter location and signal parameter estimation” by R. O. Schmidt, IEEE Trans. Antennas Propagat. Vol. 34 (3) March (1986) pp. 276-280. Using the MUSIC method, the direction of the target object is detected based on the digital signal data xᵢ(t) (i=1, . . . , N) corresponding to each of the peak frequencies with respect to each channel over one period of 2×ΔT in the saw-toothed waveform of the frequency variation of the radio frequency signal. If a plurality of peak frequencies is detected, it is expected that there are a plurality of target objects whose number is equal to that of the peak frequencies. Thus, the directions of the target objects are obtained with respect to each of the upward modulated section and the downward modulated section. Those data including the peak frequencies and the directions of the target objects with respect to the upward modulated section and the downward modulated section will hereinafter be referred as to a first target direction information and a second target direction Information, respectively.

In the present embodiment, the peak frequencies are obtained based on all N×Mₛₐₘₚ pieces of sampled data of each of the first and second digital data. In this embodiment, all N×Mₛₐₘₚ pieces of sampled data are averaged over N channels, then Mₛₐₘₚ pieces of sampled data of each of the first and second digital data are used to obtain the peak frequencies.

Further, it is allowed to estimate the peak frequencies based on down-converted data obtained by subsampling the full N×Mₛₐₘₚ pieces of sampled data of the first and second digital data. Then the procedure proceeds to step S160.

At step S160, a pair matching process in which the first target direction information and the second target direction information are compared is executed. One of aims of performing the pair matching process is to extract multiple target objects. As a result of the pair matching process, pair data comprising a value from the first target direction information and the corresponding value from the second target direction information are provided.

In general, both in the first and second digital data corresponding to the upward and downward modulated sections, respectively, include multiple intensity peaks, each intensity peak corresponding to beat frequencies, in the measuring frequency range. Each of those intensity peaks can be considered to indicate the presence of a target object. However, it is need to establish a pair of peak frequencies, one being extracted from the first digital data and another being extracted from the second digital data, to calculate the target object characteristic. If M intensity peaks are included in each of the first and second digital data, M×M pairs of beat frequencies are possible. Thus, the pair data has at most M×M pairs of peak frequencies.

At step S180, the pair data are utilized to give distance of one of candidates target objects and relative speed of the candidates target objects.

If M intensity peaks are included in each of the first and second digital data, at most M×M distances to candidate target objects and M×M relative speeds of the candidate target objects are calculated. It can be considered that among M×M candidate target objects, (M−1)×M candidate target objects are artefacts which can not present in the real world. The artefacts would be identified at next step S180.

It is allowed that previously obtained direction information may have been stored in the memory of the signal processing unit 30 and can be referred to perform the pair matching process in which one of the peak frequencies in the first target direction information and the corresponding peak frequency in the second target direction Information should be associated to identify one of the target objects. That is, it is preferable that the current first target direction information and the current second target direction information are stored in the memory of the signal processing unit 30 to be used in next time. Instead of the current first target direction information and the current second target direction information, all digital data xᵢ(t) (i=1, . . . , N) corresponding to the peak frequencies with respect to all N channels and with respect to the upward modulated section and the downward modulated section can be stored. Further, it is allowed that the power spectrum of the beat signal obtained at step S120 are stored in the memory.

Then, at step S180, the distances of the target objects and the relative speeds of the target objects are determined based on the pair data calculated at step S170.

For example, all candidates for distances of the candidate target objects and relative speeds of the candidate target objects are examined in terms of consistency of the target objects' motions. That is, if some consistent physical tracks of candidates for the target objects can be traced, the candidates would be judged to be real target objects. In this case, it is necessary to refer to target object characteristic including distance to the target objects and relative speed of the target objects at a time when the FMCW radar 2 has performed the detecting procedure defined by steps S110-S190 in FIG. 5.

Further, it is allowed that balances of intensities of peak frequencies which constituted of one of the pairs of the peak frequencies can be examined. A large imbalance in the intensities of the peak frequencies suggests that two peak frequencies are generated by different target objects.

Further, it is allowed that all candidates for distances of the candidate target objects and relative speeds of the candidate target objects are examined in terms of consistency with the first and second directional data obtained at step S150.

The determined distances of the target objects and the relative speeds of the target objects can be used for an auto-cruise operation, for a vehicle-navigating operation, or for controlling safety system installed in the vehicle.

Further, at step S180, the determined distances of the target objects and the relative speeds of the target objects are memorized in the memory of the signal processing unit 30 to be referred in the next detecting procedure.

If the determination at step S140 is “YES”, that is, at least one of the first and second integral values exceeds a predetermined Interference threshold value, it is determined that some interference by some other radar is present. Then, the procedure proceeds to step S190.

At step S190, some measures are taken against the interference between the FMCW radar and some other radar.

For example, if target object detection is impossible, an alarm is given to a driver of the vehicle equipped with the FMCW radar 2. Some other measure will be taken against the interference between the FMCW radar and some other radar via a display indication or a sound alarm.

Next, referring to FIGS. 6-9, the detailed operations for calculating each of the first and second reference values with respect to each of the frequency increasing section and in the frequency decreasing section will be discussed.

In order to calculate the first reference value, the first frequency characteristic obtained at step S120 in FIG. 5 will be used. In addition, the second frequency characteristic will be used to calculate the second reference value. These two values indicate the level of interference between the FMCW radar 2 and some other radar and determine the noise floor level of the beat signal.

One of the aspects of the present embodiment provides a radar that is capable of detecting occurrence of interference between the radar and some other radar reliably, and measuring target characteristic such as presence of a target object within the measuring distance range of the radar system, distance between the radar system and the target object, and relative velocity of the target object to the radar system accurately, even if some large or long obstacles such as trucks and lorries, or large and long buildings such as a freeway bridge and its piers exists beyond the measuring distance range of the radar, and even if there are multiple target objects within the measuring distance range of the radar.

FIG. 6 is a flow chart showing process for calculating the reference value according to the present embodiment. The process includes steps of identifying a peak frequency interval containing one of peak frequency components having a peak intensity larger than a predetermined threshold value in the frequency spectrum characteristic of the beat signal, and replacing the peak intensity with an adjusted value smaller than or equal to the intensity threshold value.

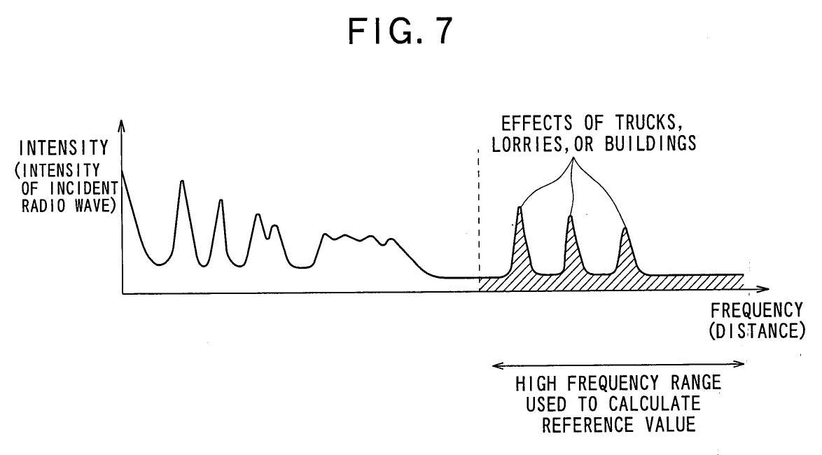

FIG. 7 is a graph showing exemplary power spectrum characteristic of the beat signal when there are some large obstacles located far beyond the measuring distance range of the FMCW radar.

As can be seen in FIG. 7, some large target obstacles located far beyond the measuring distance range of the FMCW radar induce three intensity peaks within the high frequency range in the frequency spectrum characteristic of the beat signal.

At step S210, the signal processing unit 30 detects a peak frequency component having a maximum intensity whose peak intensity is larger than the predetermined threshold value in the high frequency range in the first or second frequency spectrum characteristic of the beat signal obtained at step S120.

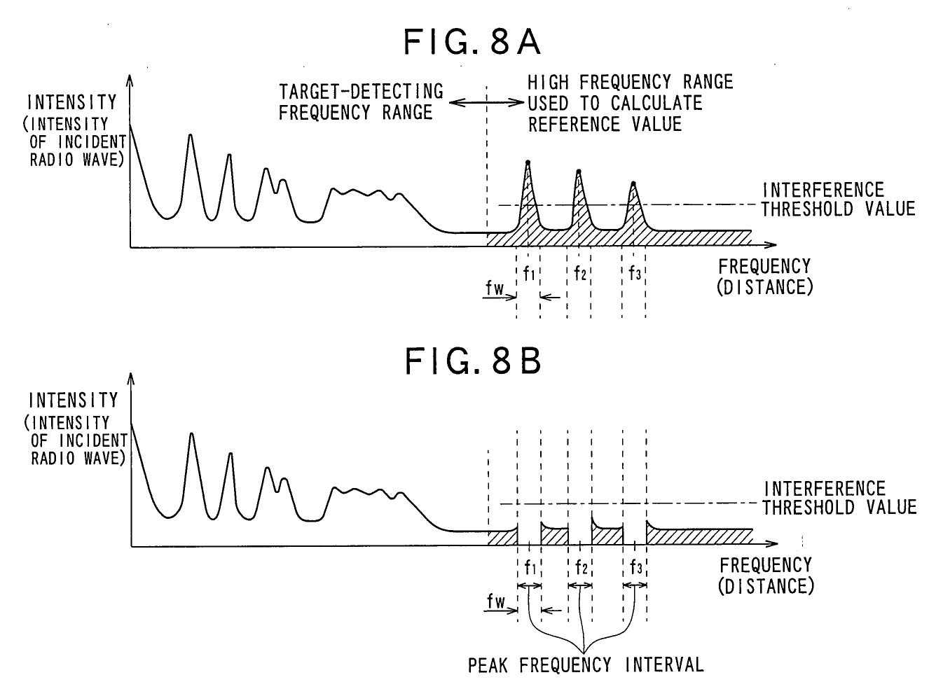

FIG. 8A is a graph showing exemplary power spectrum characteristic of the beat signal in which three peak frequency intervals containing peak frequency components, f₁, f₂, and f₃ whose intensities (peak intensities) are larger than the predetermined threshold value are seen within the high frequency range. These three peak frequency intervals will be referred as to a first, a second, and a third peak frequency interval, respectively.

Then, at step S220, it is judged of whether or not there is within the high frequency range at least one peak frequency component that has intensity exceeding the predetermined threshold value. If a result of the determination at step S220 is “YES”, that is, there is at least one peak frequency component that has intensity exceeding the predetermined threshold value, the procedure proceeds to step S230. In the other case where a result of the determination at step S220 is “NO”, that is, when there is no peak frequency component that has intensity exceeding the predetermined threshold value, the procedure jumps to step S250.

At step S230, the i-th peak frequency interval (i=1, 2, . . . ) which has its center at the peak frequency component fᵢ and the frequency width of f_{w} is selected in frequency domain. That is, the i-th peak frequency interval covers from fᵢ−f_{w}/2 to fᵢ+f_{w}/2 in frequency domain.

FIG. 8B is a graph showing process according to the first embodiment for setting three peak frequency intervals that have the centers of peak frequency intervals at three peak frequency components, f₁, f₂, and f₃, respectively, and have the same width f_{w}.

If a frequency distance of some neighboring peak frequency components is smaller than f_{w}, those two peak frequency intervals are combined to recognize one peak frequency interval having a broader width than the width of f_{w}.

At step S240, the intensities of the frequency components included within a peak frequency interval are reduced to an average value of the intensity of the lowest frequency component in the peak frequency interval and the further intensity of the highest frequency component in the peak frequency interval.

Replacing the intensities exceeding the predetermined threshold value with lower values may lead to reduce effect of the obstacles beyond the measuring distance range of the FMCW radar 2 on the frequency spectrum characteristic of the beat signal.

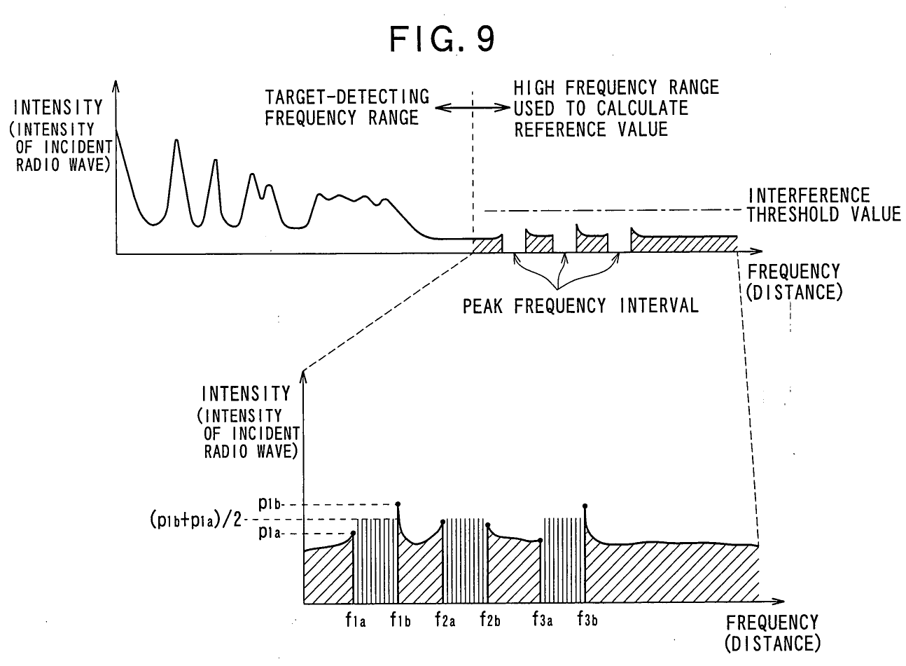

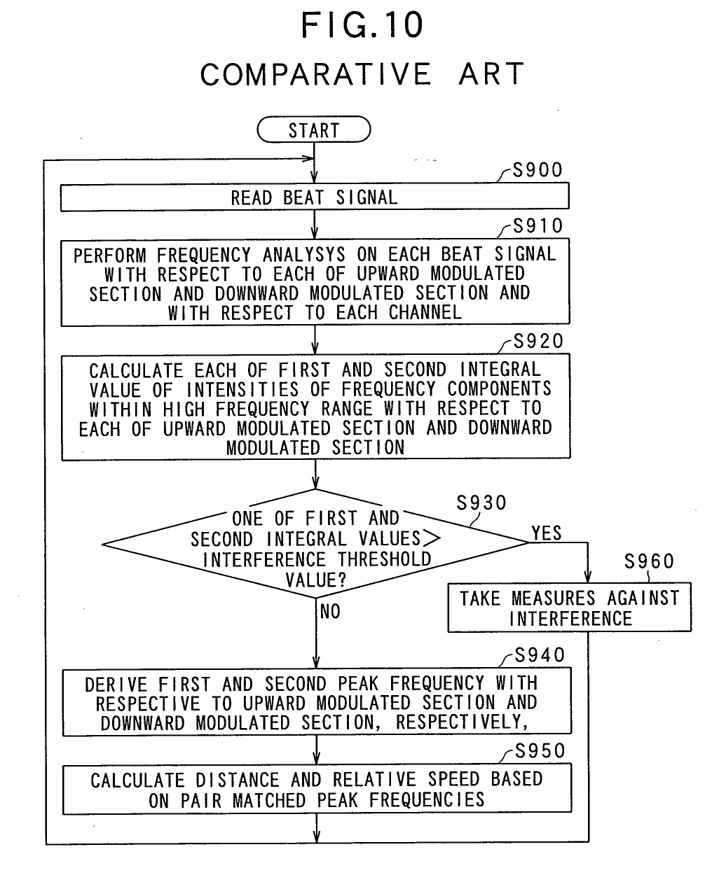

FIG. 9 is a graph showing process according to the first embodiment for replacing the intensities of three peak frequency Intervals containing three peak frequency components, f₁, f₂, and f₃ with adjusted intensities that is average values of intensities of the lowest and highest frequency components in the respective peak frequency intervals.

As can be seen in FIG. 9, three peak frequency intervals, which include the peak frequency components, f₁, f₂, and f₃, have pairs of edges of the peak frequency intervals, f₁ₐ and f_{1b}, f₂ₐ and f_{2b}, and f₃ₐ, and f_{3b}, respectively. Let the lowest frequency in the i-th peak frequency be fᵢₐ, and the highest in the i-th peak frequency be f_{ib}. Further, let the intensities of the lowest and the highest frequencies in the i-th peak frequency interval be pᵢₐ and p_{ib}, respectively. In the present embodiment, the reduced intensity of the frequency components within the i-th peak frequency interval is calculated as (pᵢₐ+p_{ib})/2 that is smaller than the predetermined threshold value. Hence, the frequency components within the i-th peak frequency interval have the same intensity of (pᵢₐ+p_{ib})/2. As a result of reduction of the intensities of the frequency components within the peak frequency intervals, a corrected frequency spectrum characteristic of the beat signal is obtained. If the operation defined at this step S240 is applied to the first and second frequency spectrum characteristics, the corrected first and second frequency spectrum characteristics are obtained. In the corrected frequency spectrum characteristic of the beat signal, all of the intensities of ones of the frequency components within the high frequency range are smaller than the predetermined threshold value. Then, the procedure proceeds to step S250.

At step S250, a reference value is calculated by integrating the intensities of the frequency components over the high frequency region using the corrected frequency spectrum characteristic of the beat signal. During the integration, the adjusted intensity (pᵢₐ+p_{ib})/2 is used as intensities within the i-th peak frequency interval. Hence the reference value is not influenced by effect of the obstacle located out of the measuring distance range of the FMCW radar 2.

### Advantages of the Present Embodiment

Therefore, the radar 2 is capable of determining noise floor level accurately, detecting occurrence of interference between the radar and some other radar reliably, and measuring target characteristic such as presence of a target object within the measuring distance range of the FMCW radar 2, distance between the FMCW radar 2 and the target object, and relative velocity of the target object to the FMCW radar 2 accurately, even if some large or long target obstacles such as trucks and lorries, or large and long buildings such as a freeway bridge and its piers exist beyond the measuring distance range of the FMCW radar 2, and even if there are multiple target objects within the measuring distance range of the FMCW radar 2.

As discussed above, in the present embodiment, a peak frequency component having peak intensity larger than the predetermined threshold value in the high frequency range of the frequency spectrum characteristic of the beat signal are detected. Then, the peak frequency interval having the frequency width is determined around the peak frequency component in the frequency domain. It is preferable that the center of the peak frequency interval is positioned at the peak frequency component in the frequency domain. Further, the intensity of the peak frequency is reduced to a reduced intensity that is smaller than or equal to the predetermined threshold value. All of the intensities of the frequency components within the peak frequency interval are replaced by the reduced intensity of the frequency components within the peak frequency interval. The reduce intensity of the frequency components within the peak frequency interval is a feature of the corrected frequency spectrum characteristic. The reduce intensity of the frequency components within the peak frequency interval and the intensities of the frequency components out of the peak frequency interval in the high frequency range are used to calculate a reference value that indicates interference level between the FMCW radar 2 and some other radar by summing up those intensities over the frequency components within the high frequency range.

Hence, the FMCW radar 2 can remove influence of an obstacle located out of the measuring distance range on the frequency spectrum characteristic of the beat signal that is translated from the incident radio wave received by the FMCW radar 2 including a return of the radar wave transmitted from the FMCW radar 2. Hence, it is possible to determine presence of interference between the FMCW radar 2 and some other radar with improved accuracy, because effect of the obstacle located out of the measuring distance range leading to increases the noise floor level of the beat signal and to increase the sum of intensities of the high frequency components has been removed.

Referring to FIGS. 10 to 14, some advantages of the present embodiment will be explained in comparison with a comparative art which determines whether interference between the FMCW radar and some other radar occurs based on the integral of intensities of high frequency components in the frequency spectrum characteristic of the beat signal.

FIG. 10 is a flow chart showing a process for detecting the target object according to a comparative art.

In the flow chart shown in FIG. 10, steps S900, S910, S940, S950, and S960 correspond to steps S110, S120, S160, 5170, and S190 in the present embodiment shown in FIG. 5. Hence unknown steps that are needed to be explained can only be seen in steps S920 and 5930.

At step S920, integral values are calculated by integrating Intensities of frequency components within a predetermined high frequency range with respect to each of the upward modulated section and the downward modulated section and with respect to each channel. If the maximum measurement frequency is set to the same value with that in the present embodiment, that is, 116 kilohertz which corresponds to 256 meters when the relative speed of the target object is zero, the predetermined high frequency range can be set to be 200 to 333 kilohertz.

Then, at step S930, it is determined whether the integral values calculated in step S920 are larger than a predetermined threshold. In the determination performed at step S930, it is sufficient to compare the predetermined value with one of the integral values for the upward modulated section and the downward modulated section.

The other steps have the same function with the corresponding steps in the method according to the present embodiment.

Instead of the integral values, it is possible to use a number of frequency components which are in the predetermined high frequency range and have an intensity exceeding a predetermined intensity threshold.

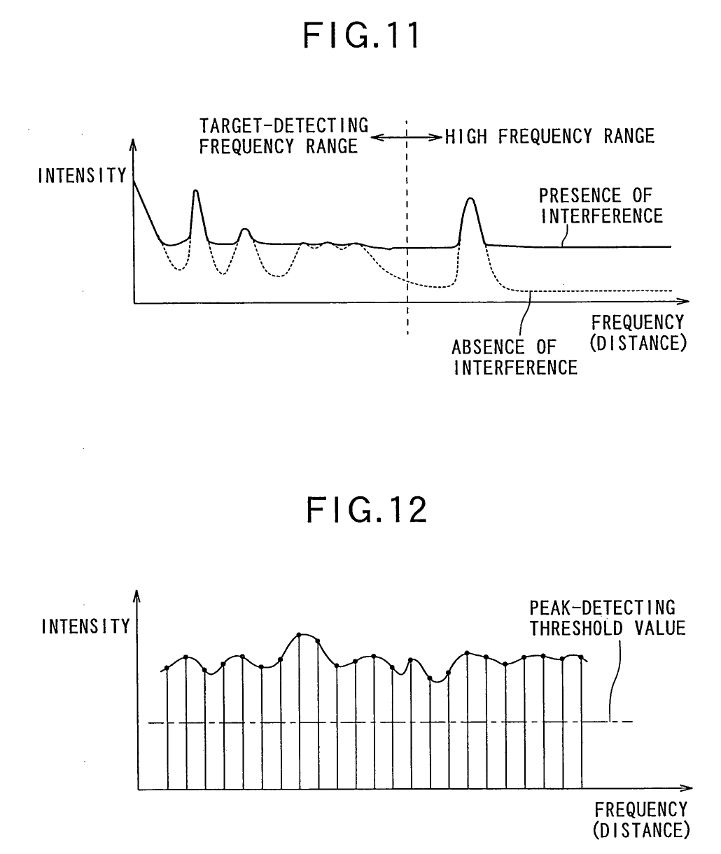

FIG. 11 is a graph showing exemplary frequency spectrum characteristic of the beat signal when interference between the FMCW radar and some other radar occurs. In FIG. 11, the predetermined high frequency range can be seen. The lower limit of the predetermined high frequency range is the maximum measurement frequency below which frequency components corresponding to the target object within the measuring distance range of the FMCW radar 2 are positioned.

FIG. 12 is a graph showing exemplary frequency spectrum characteristic of the beat signal in the high frequency range when interference between the FMCW radar and some other radar occurs. It can be seen that in the whole high frequency range the noise floor level is raised. Hence, the frequency components which have an intensity exceeding the predetermined intensity threshold are found in the whole of the high frequency range. Thus, the method according to the comparative art gives an accurate result of determination of the occurrence of interference by some other radar in this case.

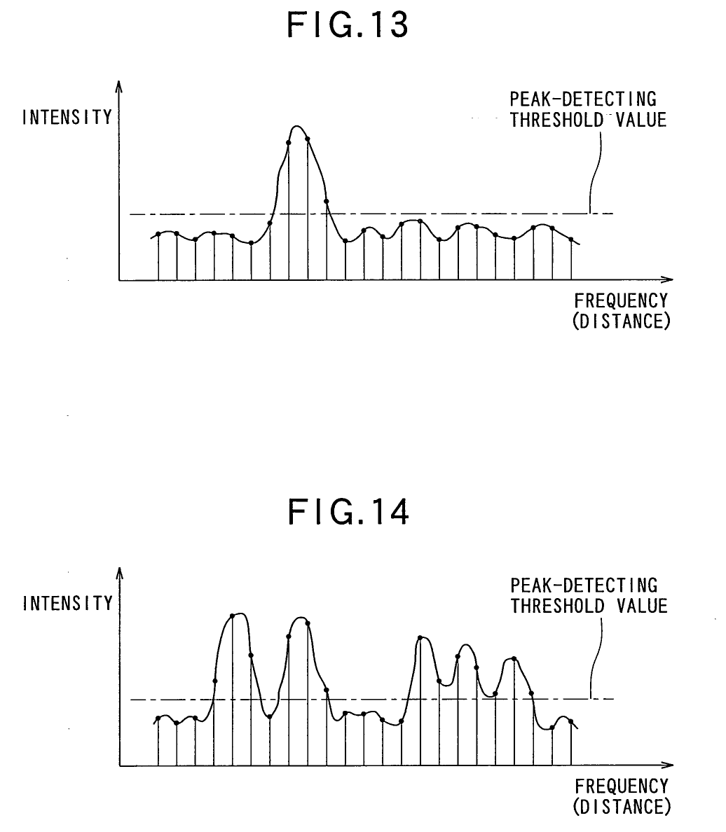

FIG. 13 is a graph showing an exemplary frequency spectrum characteristic of the beat signal in the high frequency range when no interference between the FMCW radar and other radar(s) occurs and no large target objects located far beyond the measuring region of the FMCW radar exist. In this case, the noise floor level is below the predetermined intensity threshold except in a frequency range where the effect of the target object appears. Thus, it is possible to determine whether interference between the FMCW radar and some other radar occurs. That is, the method according to the comparative art gives an accurate result of determination of the occurrence of interference by some other radar in this case.

FIG. 14 is a graph showing exemplary frequency spectrum characteristic of the beat signal in the high frequency range when interference between the FMCW radar and some other radar does not occur and some large target objects located far beyond the measuring region of the FMCW radar exist. The large target objects located far beyond the measuring region of the FMCW radar influence the frequency spectrum characteristic of the beat signal such that multiple narrow peaks which have intensities exceeding the predetermined intensity threshold are generated in the high frequency range. In this case, although interference between the FMCW radar and some other radar does not occur, both the integral values of intensities of frequency components within the predetermined high frequency range and the number of frequency components which are in the predetermined high frequency range and have an intensity exceeding the predetermined intensity threshold are increased. Hence, large target objects located far beyond the measurement region of the FMCW radar sometimes results in erroneous determinations of occurrence of interference by some other radar.

However, as described above, especially as shown at step S140 in FIG. 5, the method according to the present embodiment can estimate accurately the noise floor level. The improvement of accuracy of the determination of the noise floor level leads to reliably determine whether or not the large target objects located far beyond the measuring region of the FMCW radar.

A method according to the present embodiment for a frequency modulated continuous wave (FMCW) radar for detecting occurrence of interference between the FMCW radar and some other radar includes steps of: analyzing a beat signal containing information about a target object, detecting peak frequencies, calculating target characteristic including the downrange distance to the target object and the relative speed of the target object to the radar based on the peak frequencies, generating a histogram, detecting a noise floor level, detecting interference, and taking measures against interference.

In the step for analyzing the beat signal, the beat signal obtained by mixing the received signal Sr which relates to the amplitude of the reflected radar wave from a target object and the local signal L which relates to the radio frequency signal generated by the oscillator 12 is converted to digital data using a technique of digitizing the amplified beat signal, for example, by sampling the magnitude of the amplified beat signal at a predetermined sampling frequency to obtain a frequency spectrum characteristic or a power spectrum of the beat signal. The frequency of the radio frequency signal is modulated so as to be linearly increased within the upward modulated section, and then be linearly decreased within the downward modulated section.

In the step for detecting peak frequencies, a frequency component which is below the maximum measurement frequency and whose power exceeds a predetermined threshold value is detected as a peak frequency with respect to each of the upward modulated section and the downward modulated section. The peak frequency with respect to the upward modulated section is referred as to a first peak frequency, and another peak frequency with respect to the downward modulated section is referred as to a second peak frequency.

In the step for calculating the target characteristic of the target object, at least the distance to the target object and the relative speed of the target object are calculated based on the first and second peak frequencies.

In the step for generating the histogram, using the frequency spectrum characteristic of high frequency components of the beat signal, a histogram of the intensities of the high frequency components of the beat signal is obtained.

In the step for detecting the noise floor level, the value of the intensity or power of the beat signal which has the maximum height in the high frequency region in the histogram is detected as a noise floor level.

In the step for detecting interference, if the noise floor level exceeds a predetermined interference threshold value, it is determined that some interference by some other radar is present.

In the step for taking measure against interference, some measure is taken against the interference by some other radar.

Therefore, it is possible to reliably determine whether or not large target objects are located far beyond the measuring region of the FMCW radar because the accuracy of the determination of the noise floor level is improved. Thus, countermeasures against interference can be taken in a timely manner.

### A First Modification of the First Embodiment

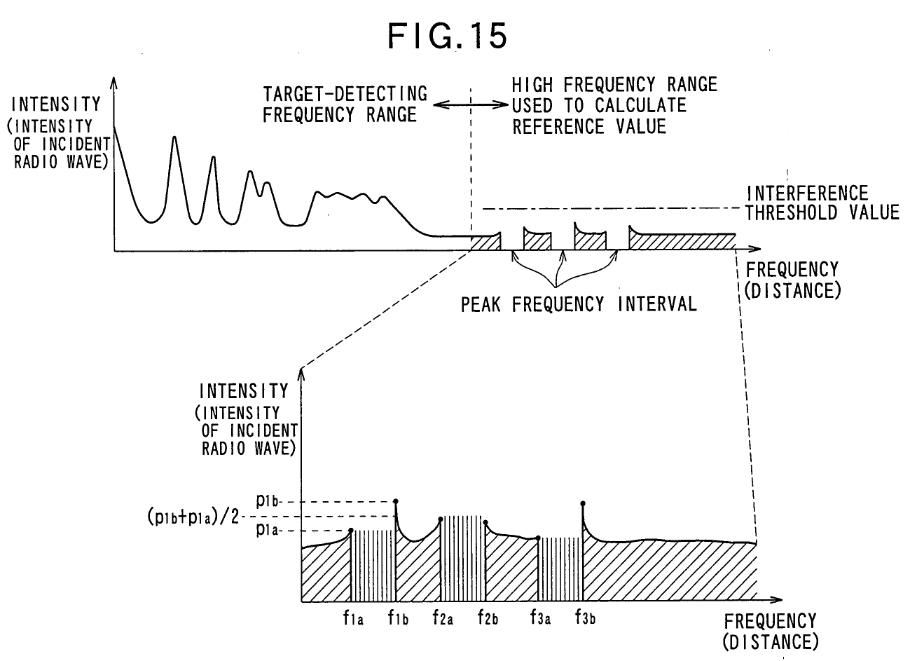

Referring to FIG. 15, a first modification of the first embodiment will be discussed.

FIG. 15 is a graph showing a process according to a first modification of the first embodiment for replacing the intensities of three peak frequency intervals containing three peak frequency components, f₁, f₂, and f₃ with corrected values that is identical to value of intensities of the lowest frequency component in the respective peak frequency intervals.

In this modification, the operation at step S240 in FIG. 6 is modified. In the first embodiment, the corrected intensity of the frequency components within the i-th peak frequency interval is calculated as (pᵢₐ+p_{ib})/2. However, in the first modification of the first embodiment, the corrected intensity of the frequency components within the i-th peak frequency interval is set to pᵢₐ which is smaller than the predetermined threshold value. That is, the frequency components within the i-th peak frequency interval have the same corrected intensity of pᵢₐ which is the intensity of the lowest frequency in the i-th peak frequency interval.

In this modification of the first embodiment, the same advantages with those of the first embodiment can be obtained.

### A Second Modification of the First Embodiment

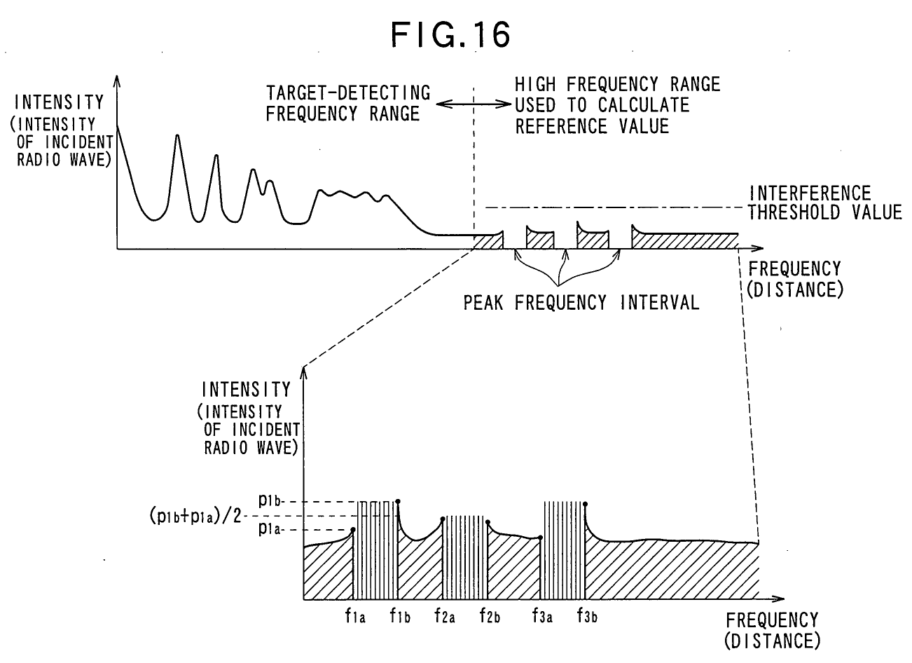

Referring to FIG. 16, a first modification of the first embodiment will be discussed.

FIG. 16 is a graph showing a process according to a second modification of the first embodiment for replacing the intensities of three peak frequency intervals containing three peak frequency components, f₁, f₂, and f₃ with adjusted values that is values of intensities of the highest frequency component in the respective peak frequency intervals.

In this modification, the operation at step S240 in FIG. 6 is modified. In the second modification of the first embodiment, the corrected intensity of the frequency components within the i-th peak frequency interval is set to p_{ib} that is the intensity of the highest frequency component within the i-th peak frequency interval. That is, the frequency components within the i-th peak frequency interval have the same corrected intensity of p_{ib} which is smaller than the predetermined threshold value.

Further it is allowed that the corrected intensity of the frequency components within the i-th peak frequency interval is calculated as a linear combination of the intensities pᵢₐ and p_{ib} of the lowest and the highest frequencies in the i-th peak frequency interval which gives a value higher than min(pᵢₐ,p_{ib}) and lower than max(pᵢₐ,p_{ib}), where min(pᵢₐ,p_{ib}) is a smaller value between pᵢₐ and p_{ib}, and max(pᵢₐ,p_{ib}) is the larger value between pᵢₐ and p_{ib}.

In this modification of the first embodiment, the same advantages with those of the first embodiment can be obtained.

### Second Embodiment

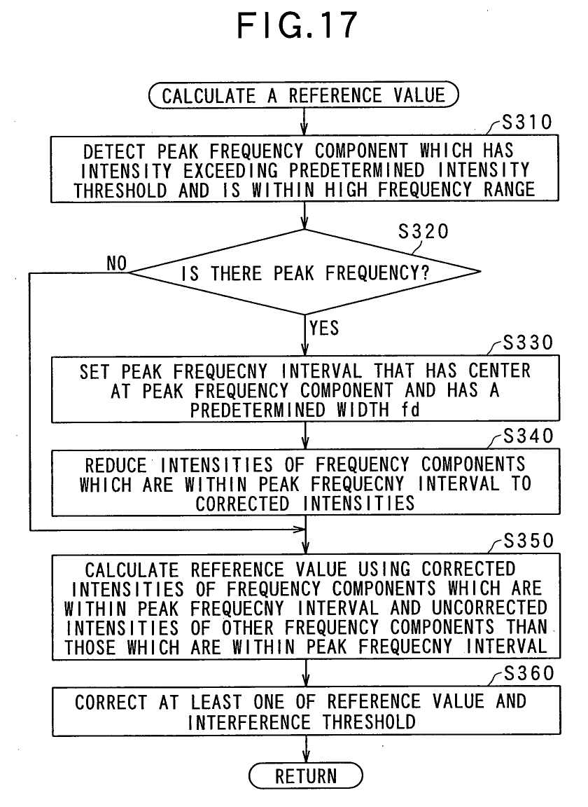

Referring to FIG. 17, a second embodiment of the present invention will be discussed.

FIG. 17 is a flow chart showing process for calculating the reference value according to the second embodiment of the present invention, the process including steps of identifying a peak frequency interval containing one of peak frequency components having a peak intensity larger than the predetermined threshold value in frequency spectrum characteristic of the beat signal, and replacing the peak Intensity with zero level in the intensity.

In this embodiment, operation at step S130 in FIG. 5 for calculating the first and the second reference values with respect to each of the frequency increasing section and the frequency decreasing section is modified from that in the first embodiment. So, in the following, operation for calculating the first and the second reference values according to the present embodiment will be explained.

In the present embodiment, the following operation will be performed with respect to the frequency increasing section and the frequency decreasing section separately.

At step S310, the signal processing unit 30 detects a peak frequency component having a maximum intensity whose peak intensity is larger than the predetermined threshold value in the high frequency range in using the frequency spectrum characteristics of the beat signal with respect to the frequency increasing section and the frequency decreasing section, wherein the frequency spectrum characteristics are obtained at step S120.

At subsequent step S320, it is judged of whether or not there is within the high frequency range at least one peak frequency component that has intensity exceeding the predetermined threshold value. If a result of the determination at step S320 is “YES”, that is, there is at least one peak frequency component that has intensity exceeding the predetermined threshold value, the procedure proceeds to step S330. In the other case where a result of the determination at step S320 is “NO”, that is, when there is no peak frequency component that has intensity exceeding the predetermined threshold value, the procedure jumps to step S350.

At step S330, the i-th peak frequency interval (i=1, 2, . . . ) which has the center at the peak frequency component fᵢ and the frequency width of f_{w} is set in the frequency domain. That is, the i-th peak frequency interval covers from fᵢ−f_{w}/2 to fᵢ+f_{w}/2 in frequency domain.

If a frequency distance of neighboring peak frequency components is smaller than f_{w}, those two peak frequency intervals are combined to recognize one peak frequency interval having a broader width than the frequency width of f_{w}.

At step S340, the intensities of the frequency components included within a peak frequency interval are replaced with zero level in the intensity. Then, the procedure proceeds to step S350.

At step S350, a first and a second reference values are calculated by integrating the intensities of the frequency components with respect to the frequency increasing section and the frequency decreasing section over the high frequency region, respectively. This means that the first and second reference values are obtained based on the intensity of the frequency components which are in the high frequency range and are not in the peak frequency interval.

At step S360, at first, if there be a plurality of the peak frequency intervals, the signal processing unit 30 calculates a sum of the widths of the peak frequency intervals to give a total width wk of the peak frequency intervals. If there is one peak frequency interval, the total width Wk of the peak frequency interval is identical to the frequency width of f_{w}. Then, the first and second reference values obtained at step S350 are corrected by multiplying those reference values by a correcting factor.

For example, let the frequency width of the high frequency range be Wa, the first and second reference values obtained at step S350 be S₁ and S₂, and the corrected first and second reference values be Sh₁ and Sh₂, respectively. Thus, the corrected first and second reference values be Sh₁ and Sh₂ are calculate as follows:

$$\begin{matrix}{Sh}_{1} = {S}_{1} \times \frac{Wa}{( Wa - Wk )} , & ( 5 ) \\ {Sh}_{2} = {S}_{2} \times \frac{Wa}{( Wa - Wk )} . & ( 6 )\end{matrix}$$

Since Wa/(Wa−Wk)>1, if there is a peak frequency interval, the first and second reference values are enhanced in the correction. In the correction of the first and second reference values defined by equations (5) and (6), the intensities of the frequency components within the peak frequency interval are set to an average value of the intensities of the frequency components which are in the high frequency range and are not in the peak frequency interval.

### Advantages of the Present Embodiment

As described above, in the present embodiment, the method for calculating the reference values to be used in determining whether interference between the FMCW radar 2 and some other radar comprising steps of: detecting a peak frequency component or peak frequencies, setting a peak frequency interval or peak frequency intervals in the frequency domain, resetting the intensities of the frequency components within the peak frequency interval(s), calculating a first and a second reference values, calculating a sum of the width of the peak frequency intervals, and correcting the first and second reference values.

In the step of detecting a peak frequency component, it is judged of whether or not there is within the high frequency range at least one peak frequency component that has intensity exceeding the predetermined threshold value.

In the step of setting a peak frequency interval or peak frequency intervals, the i-th peak frequency interval (i=1, 2, . . . ) which has the center at the peak frequency component fᵢ and the frequency width of f_{w} is set in the frequency domain.

In the step of resetting the intensities of the frequency components within the peak frequency interval(s), the intensities of the frequency components within the peak frequency interval(s) are reduced zero level in the intensity to remove effect of obstacle located out of the measuring distance range of the FMCW radar 2 on the frequency spectrum characteristics of the beat signal.

In the step of calculating a first and a second reference values, integrations of the intensities of the frequency components with respect to the frequency increasing section and the frequency decreasing section over the high frequency region, respectively, are performed to obtain the first and second reference values.

In the step of calculating the sum of peak frequency intervals to give a total width of the peak frequency intervals if there are a plurality of the peak frequency intervals. If there is one peak frequency interval, the width of the peak frequency interval should be read as a total width.

In the step of correcting the first and second reference values, the first and second reference values are multiplied by a correcting factor that is a function of the ratio of the total width of the peak frequency intervals to the frequency width of the high frequency range.

The corrected first and second reference values are used to determine whether interference between the FMCW radar 2 and some other radar occurs at step S140. At step S140, the signal processing unit 30 compares the first and second reference values with a predetermined interference threshold value.

The obstacle located out of the measuring distance range of the FMCW radar 2 causes a return of the radar wave which generates peaks within the high frequency range in the frequency spectrum characteristic of the beat signal. Hence, in the method according to the present embodiment for calculating the reference values to be used in determining whether interference exists between the FMCW radar 2 and some other radar, enhancement of the sum of the intensities of the frequency components of the beat signal within the high frequency range due to the obstacle can be reduced. Thus, effects of the obstacle located out of the measuring distance range on the beat signal can be removed in the analysis of the beat signal.

In the present embodiment, the same advantages with those of the first embodiment can be obtained.

Further, it is allowed that instead of correcting the first and second reference values as discussed above, the interference threshold value which is used in step S140 in FIG. 5 can be corrected based on the ratio of the total width of the peak frequency intervals to the frequency width of the high frequency range.

For example, if let the interference threshold value be T, a corrected interference threshold value Th is calculated according to the following equation:

$$Th = T \times \frac{( Wa - Wk )}{Wa} . \qquad ( 7 )$$

Since (Wa−Wk)/Wa<1, if there is at least one the peak frequency interval, the interference threshold value is reduced in the correction One of the ideas contained in the above correction of the interference threshold value is as follows: as a result of operation performed at the step of resetting the intensities of the frequency components within the peak frequency interval(s), interference between the FMCW radar 2 and some other radar cannot influence on the sum of the intensities of the frequency components within the high frequency range so that the reference values, i.e., the sum of intensities is underestimated. Hence it is necessary to correct the interference threshold value so as to compensate for the reduced amount of the reference values. In equation (7), reduction of the reference value is equivalent to replacing each of the intensities of the frequency components within the peak frequency interval with an average intensity of the intensities of the frequency components which are in the high frequency range and are not in the peak frequency interval.

Further, it is allowed that both the reference values and the interference threshold value may be corrected according to the following equations:

$$\begin{matrix}{Sh}_{1} = \frac{{S}_{1}}{Wa} , & ( 8 ) \\ {Sh}_{2} = \frac{{S}_{2}}{Wa} , & ( 9 ) \\ Th = \frac{T}{Wa} . & ( 10 )\end{matrix}$$

That is, the corrected first and second reference values Sh₁ and Sh₂ are set to be the respective average values of the intensities of the frequency components which are in the high frequency range with respect to the frequency increasing section and the frequency decreasing section, respectively. Further, the interference threshold value is corrected to give the corrected interference threshold vale Th according to the same formula used in the corrected first and second reference values Sh₁ and Sh₂.

### Third Embodiment

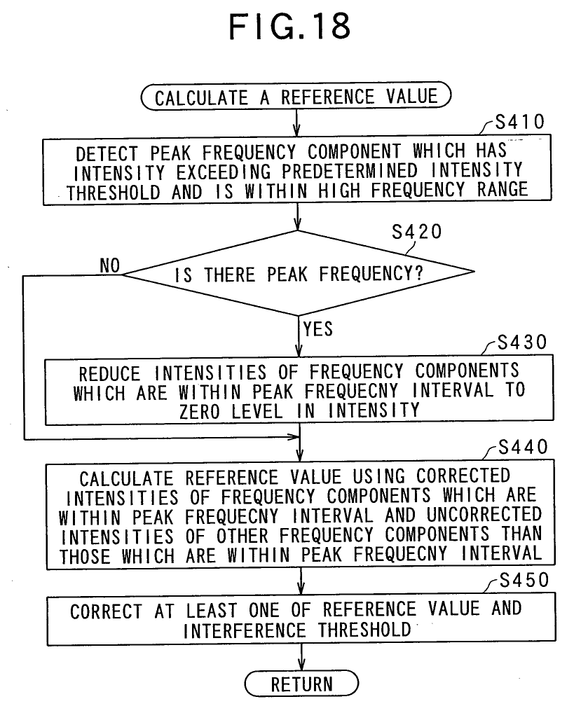

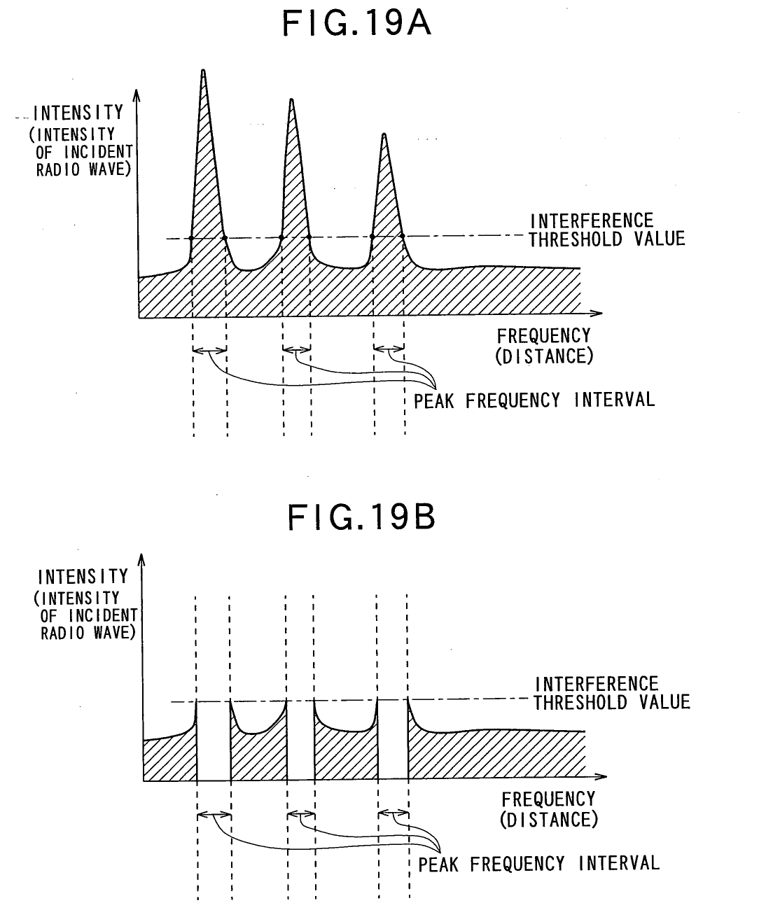

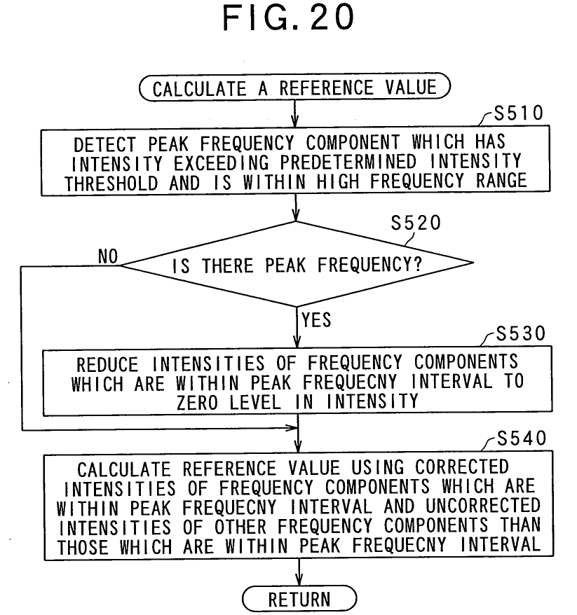

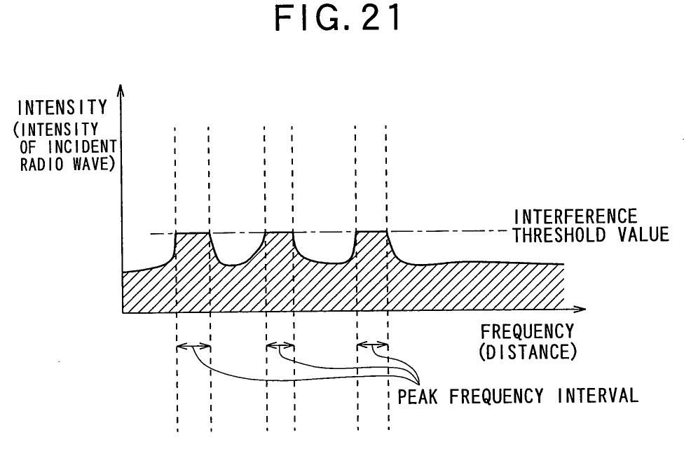

Referring to FIG. 18-19B, a third embodiment of the present invention will be discussed.

In this embodiment, operation at step S130 in FIG. 5 for calculating the first and the second reference values with respect to each of the frequency increasing section and the frequency decreasing section is modified from that in the first embodiment. So, in the following, operation for calculating the first and the second reference values according to the present embodiment will be explained.

FIG. 18 is a flow chart showing a process for calculating the integral value according to a third embodiment of the present invention, the process including steps of identifying a peak frequency interval containing one of the frequency components having intensity larger than the predetermined threshold value in frequency spectrum characteristic of the beat signal, and replacing the peak intensity with zero level in the intensity.

In the present embodiment, the following operation will be performed with respect to the frequency increasing section and the frequency decreasing section separately.

At step S410, the signal processing unit 30 detects a high intensity area in the frequency spectrum characteristic. The high intensity area is determined in the frequency spectrum characteristic such that intensity is larger than a predetermined threshold value in the high frequency range in the frequency spectrum characteristics of the beat signal with respect to the frequency increasing section and the frequency decreasing section, which frequency spectrum characteristics are obtained at step S120.

FIG. 19A is a graph showing an exemplary frequency spectrum characteristic of the beat signal in the high frequency range when there are some obstacles located far beyond the measuring region of the FMCW radar 2.

In the frequency spectrum characteristic shown in FIG. 19A, three high intensity areas whose intensities exceed the predetermined threshold value can be found within the high frequency range. Then, each of three peak frequency intervals contains frequency components which have intensities exceeding the predetermined threshold value. The peak frequency interval has the minimum and maximum frequencies at which intensities are equal to the predetermined threshold value.

At subsequent step S420, it is judged of whether or not there is at least one peak frequency interval within the high frequency range. If a result of the determination at step S420 is “YES”, that is, there is at least one peak frequency interval within the high frequency range, the procedure proceeds to step S430. In the other case where a result of the determination at step S420 is “NO”, that is, when there is at least one peak frequency interval within the high frequency range, the procedure jumps to step S440.

It should be noted that at step S420 the signal processing unit 30 does not detect individual peak frequency component having peak intensity larger than the predetermined threshold value in the high frequency range. Instead of this, a fraction of intensities exceeding the predetermined threshold value is detected.

At step S430, the intensities of the frequency components included within a peak frequency interval are replaced with zero level in the intensity, as shown in FIG. 19B.

FIG. 19B is a graph showing a process according to a first modification of the first embodiment for replacing the intensities of three peak frequency intervals containing three peak frequency components with zero level in intensity. Then, the procedure proceeds to step S440.

At step S440, a first and a second reference values are calculated by integrating the intensities of the frequency components with respect to the frequency increasing section and the frequency decreasing section over the high frequency region, respectively. This means that the first and second reference values are obtained based on the intensity of the frequency components which are in the high frequency range and are not in the peak frequency interval, as shown in FIG. 19B. Then, the procedure proceeds to step S450.

FIG. 19B is a graph showing a process according to the third embodiment for replacing the intensities of three peak frequency intervals containing three peak frequency components with zero level in intensity.

At step S450, the first and second reference values obtained at step S350 are corrected by multiplying those reference values by a correcting factor. The correcting operation is the same one performed in the second embodiment. Thus, it is allowed that both the reference values and the interference threshold value might be corrected according to the equations (8)-(10).

In the present embodiment, the same advantages with those of the previous embodiments can be obtained.

Further, in the present embodiment, a simpler operation for setting a peak frequency interval or peak frequency intervals than those of the previous embodiments is used. Hence, it is possible to perform the method for detecting presence of interference between the FMCW radar 2 and some other radar in a simpler manner than those adopted in the previous embodiments.

### Fourth Embodiment

Referring to FIG. 20-21, a fourth embodiment of the present invention will be discussed.

In this embodiment, operation at step S130 in FIG. 5 for calculating the first and the second reference values with respect to each of the frequency increasing section and the frequency decreasing section is modified from that in the previous embodiments. So, in the following, operation for calculating the first and the second reference values according to the present embodiment will be explained.

In the present embodiment, the following operation will be performed with respect to the frequency increasing section and the frequency decreasing section separately.

At step S510, the signal processing unit 30 detects a high intensity area in the frequency spectrum characteristic. The high intensity area is determined in the frequency spectrum characteristic such that intensity is larger than a predetermined interference threshold value in the high frequency range in the frequency spectrum characteristics of the beat signal with respect to the frequency increasing section and the frequency decreasing section, which frequency spectrum characteristics are obtained at step S120.

FIG. 19A is a graph showing an exemplary frequency spectrum characteristic of the beat signal in the high frequency range when there are some obstacles located far beyond the measuring region of the FMCW radar 2.

In the frequency spectrum characteristic shown in FIG. 19A, three high intensity areas whose intensities exceed the predetermined threshold value can be found within the high frequency range. Then, each of three peak frequency intervals contains frequency components which have intensities exceeding the predetermined interference threshold value. The peak frequency interval has the minimum and maximum frequencies at which intensities are equal to the predetermined interference threshold value.

At subsequent step S520, it is judged of whether or not there is at least one peak frequency interval within the high frequency range. If a result of the determination at step S520 is “YES”, that is, there is at least one peak frequency interval within the high frequency range, the procedure proceeds to step S530. In the other case where a result of the determination at step S520 is “NO” that is, when there is at least one peak frequency interval within the high frequency range, the procedure jumps to step S540.

It should be noted that at step S520 the signal processing unit 30 does not detect individually peak frequency component having peak intensity larger than the predetermined threshold value in the high frequency range. Instead of this, a fraction of intensities exceeding the predetermined threshold value is detected.

At step S530, the intensities of the frequency components included within a peak frequency interval are replaced with the predetermined threshold value in the intensity, as shown in FIG. 19C.

FIG. 21 is a graph showing a process according to the fourth embodiment for replacing the intensities of three peak frequency intervals containing three peak frequency components with the predetermined threshold value in intensity. Then, the procedure proceeds to step S540.

At step S540, a first and a second reference values are calculated by integrating the intensities of the frequency components with respect to the frequency increasing section and the frequency decreasing section, respectively, over the high frequency region. In the calculating the first and the second reference values, the corrected intensities of the frequency components obtained at step S530 are used if the frequency components are within the peak frequency intervals.

At step S450, the first and second reference values obtained at step S350 are corrected by multiplying those reference values by a correcting factor. The correcting operation is the same one performed in the second embodiment. Thus, it is allowed that both the reference values and the interference threshold value might be corrected according to the equations (8)-(10).

In the present embodiment, the same advantages with those of the previous embodiments can be obtained.

Further, in the present embodiment, a simpler operation for setting a peak frequency interval or peak frequency intervals than those of the previous embodiments is used. Hence, it is possible to perform the method for detecting presence of interference between the FMCW radar 2 and some other radar in a simpler manner than those adopted in the previous embodiments.

### Fifth Embodiment

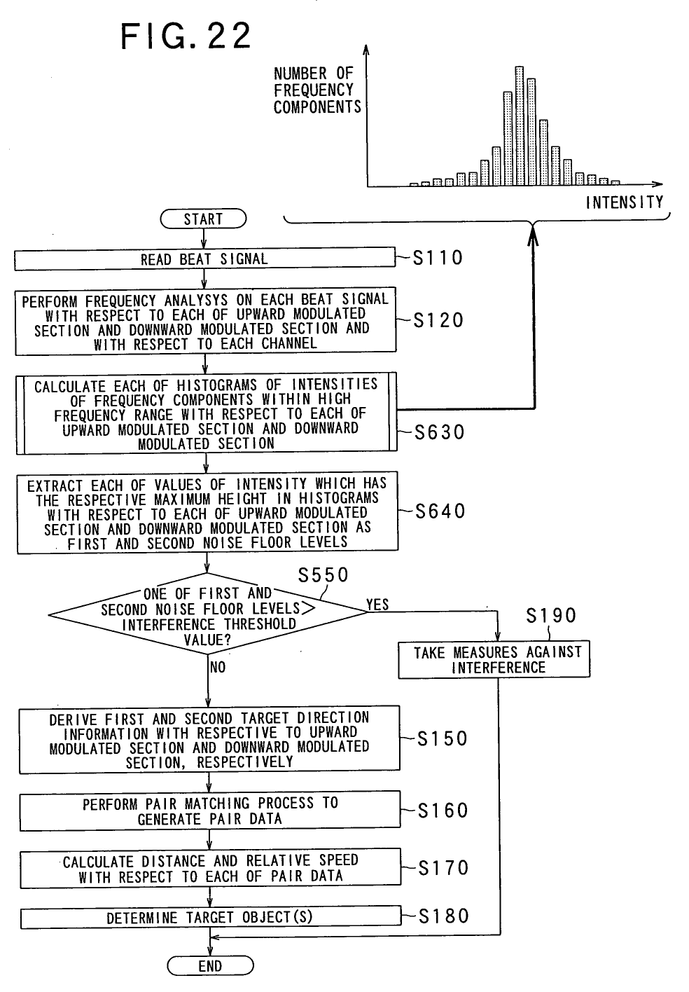

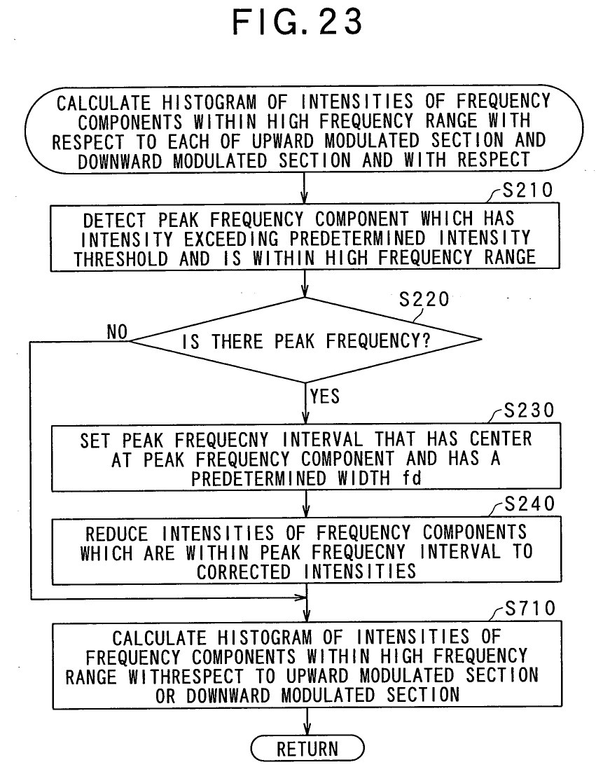

Referring to FIGS. 22-23, a fifth embodiment of the present invention will be discussed.

In this embodiment, there is provided a method for accurately detecting noise floor level of the frequency spectrum characteristic of a beat signal which is obtained by mixing a transmission signal modulating a radar wave so as to linearly vary with time and a received signal relating to a reflected radar wave from a target object, based on a histogram illustrating distribution of the intensities of the frequency components of the beat signal, in order to accurately determine whether interference between the FMCW radar and some other radar occurs even if some large or long target object such as trucks and lorries, or large and long buildings such as a freeway and its piers is at place beyond the measuring region of the FMCW radar.

The method according to the present embodiment includes steps of: performing frequency analysis on the electric signal to derive a distribution of intensities of frequency components of the electric signal, calculating a histogram of the intensities of frequency components which are out of a given frequency range in which the return of the radar wave from the target object is to fall, and determining one of the intensities having the maximum height in the histogram of the intensities of the frequency components as the noise floor level.

A method according to the present embodiment for a frequency modulated continuous wave (FMCW) radar for estimating a noise floor level that is increased in response to occurrence of interference between the FMCW radar and some other radar occurs includes steps of: analyzing a beat signal, generating a histogram, and detecting a noise floor level.

In the step for analyzing the beat signal, the beat signal obtained by mixing the received signal Sr which relates to the amplitude of the reflected radar wave from a target object and the local signal L which relates to the radio frequency signal generated by the oscillator 12 is converted to digital data using a technique of digitizing the amplified beat signal, for example, by sampling the magnitude of the amplified beat signal at a predetermined sampling frequency to obtain frequency spectrum characteristic or a power spectrum of the beat signal. The frequency of the radio frequency signal is modulated so as to be linearly increased within the upward modulated section, and then be linearly decreased within the downward modulated section.

In the step for generating the histogram, using the frequency spectrum characteristic of high frequency components of the beat signal, a histogram of the intensities of high frequency components of the beat signal is obtained.

Further, the step for generating the histogram further includes steps of: identifying a peak frequency interval containing one peak frequency components having a peak intensity larger than a predetermined threshold value in the frequency spectrum characteristic of the beat signal, and replacing peak intensities with an adjusted value smaller than or equal to the intensity threshold value to generate a corrected frequency spectrum characteristic.

FIG. 22 is a flow chart showing a process according to the fifth embodiment for calculating a noise floor level of the beat signal, the process including a step of calculating a histogram of the intensities of the frequency components in the high frequency range.

In this embodiment, instead of performing operations at step S130 and S140 in FIG. 5 for calculating the first and the second reference values with respect to each of the frequency increasing section and the frequency decreasing section is modified from that in the previous embodiments. So, in the following, operation for calculating the first and the second reference values according to the present embodiment will be explained.

At step S630, using the power spectrums of the beat signal obtained at step S120, especially using the power spectrum data corresponding to the frequency components within the high frequency range, histograms of the intensities of those frequency components of the beat signal with respect to each of the upward modulated section and the downward modulated section are obtained. The histogram shows how frequently a given intensity or power is counted in the frequency components of the frequency spectrum characteristic of the beat signal in the high frequency range. In other words, the histogram shows the distribution of the intensity or power of the beat signal with respect to the frequency components within the high frequency range. The operation performed at this step will be discussed bellow.

Then, at step S640, the signal processing unit 30 extracts the value of the intensity or power of the beat signal in the upward modulated section from the intensities of those frequency components of the beat signal such that the value has the maximum height in the histogram. The same procedure is performed with respective to the downward modulated section. The extracted values defines corresponding noise floor levels, i.e., the first noise floor level obtained based on the first digital data corresponding to the upward modulated section and the second noise floor level obtained based on the second digital data corresponding to the downward modulated section. The values of the intensity or power of the beat signal which have the respective maximum height in the histograms are referred as to peak powers. In other words, the first noise floor level is the most frequently found intensity in the histogram of the intensities of the frequency components of the beat signal within the high frequency range with respect to the upward modulated section. The second noise floor level is the most frequently found intensity in the histogram of the intensities of the frequency components of the beat signal within the high frequency range with respect to the downward modulated section.

In this embodiment, the histograms with respect to the upward modulated section and the downward modulated section are obtained based on all N×Mₛₐₘₚ pieces of sampled data of the first and second digital data, respectively. However, it is allowable that only one of the histograms with respect to at least one of the upward modulated section and the downward modulated section is obtained based only on digital data according to the beat signal that is generated by the received signal Sr including all of channels of the receiving antenna unit 20. In this case, only one value of intensity or power of the beat signal which has the maximum height in the histogram can be selected as a floor noise level.

If a plurality of values of the intensity or power of the beat signal which give the same maximum height in the histogram at the step S630, it is allowed either to recognize the lowest or the highest intensity which give the maximum height as the noise floor level or to calculate a value as a function of the values of the intensity or power of the beat signal which give the same maximum height as the noise floor level.

If only one noise floor level was obtained in the step S640, it is judged whether or not the noise floor level exceeds a predetermined interference threshold value.

In this embodiment, the noise floor level obtained at step S540 is most frequently seen in the frequency spectrum characteristic of the beat signal within the high frequency range. Thus, the procedure for determining noise floor level includes no ambiguity. Therefore, it is possible to estimate the noise floor level accurately, even if some large or long target object such as trucks and lorries, or large and long buildings such as a freeway bridge and its piers exists beyond the measuring region of the FMCW radar, and even if there are multiple target objects within the measuring range of the radar.

Subsequently at step S650, it is determined whether or not at least one of the first and second noise floor levels exceeds a predetermined interference threshold value. This determination is carried out to judge whether or not some measures will be taken against the interference between the FMCW radar and some other radar.

If the determination at step S650 is “NO”, that is, if both of the first and second noise floor levels do not exceed the predetermined interference threshold value, it is determined that neither interference between the FMCW radar and some other radar nor influence of existence of objects located far beyond the measuring region have occurred. Then the procedure proceeds to step S150.

If the determination at step S650 is “YES”, that is, at least one of the first and second noise floor levels exceeds a predetermined interference threshold value, it is determined that some interference by some other radar is present. Then, the procedure proceeds to step S190.

FIG. 23 is a flow chart showing a process according to the fifth embodiment calculating a histogram of the intensities of the frequency components in the high frequency range, the process including steps of: identifying a peak frequency interval containing one of peak frequency components having a peak intensity larger than the predetermined threshold value in frequency spectrum characteristic of the beat signal, and replacing the peak intensity with an adjusted value smaller than or equal to the intensity threshold value.

In this embodiment, instead of performing operation at step S250 in FIG. 6 for calculating the first and the second reference values with respect to each of the frequency increasing section and the frequency decreasing section, operation for calculating the histogram will be performed, as shown at step S710 in FIG. 23. So, in the following, operation calculating the histogram according to the present embodiment will be explained.

At step S710 in FIG. 23, histograms with respect to each of the frequency increasing section and the frequency decreasing section are calculated using the corrected frequency spectrum characteristic of the beat signal. During calculating the histograms, a Intensity (pᵢₐ+p_{ib})/2 is used as corrected intensities within the i-th peak frequency interval, where pᵢₐ and p_{ib} are the intensities of the lowest and the highest frequencies in the i-th peak frequency interval, respectively. Hence the reference value is not influenced by effect of the obstacle located out of the measuring distance range of the FMCW radar 2.

It should be noted that Instead of using (pᵢₐ+p_{ib})/2 as the corrected intensity, it is possible use some other formula disclosed above. For example, zero level in intensity is used as the corrected intensity within the i-th peak frequency interval.

A method according to the present embodiment for a frequency modulated continuous wave (FMCW) radar for estimating a noise floor level that is increased in response to occurrence of interference between the FMCW radar and some other radar occurs includes steps of: analyzing a beat signal, generating a histogram, and detecting a noise floor level.

In the step for analyzing the beat signal, the beat signal obtained by mixing the received signal Sr which relates to the amplitude of the reflected radar wave from a target object and the local signal L which relates to the radio frequency signal generated by the oscillator 12 is converted to digital data using a technique of digitizing the amplified beat signal, for example, by sampling the magnitude of the amplified beat signal at a predetermined sampling frequency to obtain frequency spectrum characteristic or a power spectrum of the beat signal. The frequency of the radio frequency signal is modulated so as to be linearly increased within the upward modulated section, and then be linearly decreased within the downward modulated section.

The step for generating the histogram further includes steps of: detecting a peak frequency component or peak frequencies, setting a peak frequency interval or peak frequency intervals in the frequency domain, correcting the intensities of the frequency components within the peak frequency interval(s), calculating a first and a second reference values, calculating a histogram using the corrected intensities of the frequency components within the peak frequency interval(s).

In the step of detecting a peak frequency component, it is judged of whether or not there is within the high frequency range at least one peak frequency component that has intensity exceeding the predetermined intensity threshold value.

In the step of setting a peak frequency interval or peak frequency intervals, the i-th peak frequency interval (i=1, 2, . . . ) which has the center at the peak frequency component fᵢ and the frequency width of f_{w} is set in the frequency domain.

In the step of resetting the intensities of the frequency components within the peak frequency interval(s), the intensities of the frequency components within the peak frequency interval(s) are reduced to a corrected level that is smaller than the predetermined intensity threshold value to reduce effect of obstacle located out of the measuring distance range of the FMCW radar 2 on the frequency spectrum characteristics of the beat signal.

In the step of calculating a first and a second reference values, integrations of the intensities of the frequency components with respect to the frequency increasing section and the frequency decreasing section over the high frequency region, respectively, are performed to obtain the first and second reference values.

In the step of calculating the sum of peak frequency intervals the total width of the peak frequency intervals is used if there are a plurality of the peak frequency intervals. If there is one peak frequency interval, the width of the peak frequency interval should be read as a total width.

In step for detecting the noise floor level, a value of the intensity or power of the beat signal which has the maximum height in the histogram is detected as a noise floor level.

Therefore, even if even large or long target objects, for example, large vehicles such as trucks and lorries, or buildings such as a freeway bridge and its piers are at a place further than the measuring range of the FMCW radar 2, the influence of such the large or long target objects can not be seen in the frequency spectrum characteristic of the beat in the high frequency range, because intensities of frequency components affected by such objects do not exceed the noise floor level.

Therefore, it is possible to reliably determine whether or not large target objects are located far beyond the measuring region of the FMCW radar because the accuracy of the determination of the noise floor level is improved. Thus, countermeasures against interference can be taken in a timely manner.

In the present embodiment, an alarm is notified to the driver when it is impossible to detect target objects from a vehicle equipped with the FMCW radar 2 at step S190 in FIG. 22. However, it is possible to execute steps S150 to S180 using a redefined noise floor level obtained by adding some margin to the noise floor level. In this case, the peak frequencies whose intensities exceed the noise floor level can be used to estimate the target characteristic of a target object, even if either interference between the FMCW radar and some other radar occurs or some influence from some large or long obstacles such as trucks and lorries, or large and long buildings such as a freeway bridge and its piers located beyond the measuring region of the FMCW radar appears in the frequency spectrum characteristic of the beat signal.

Further, it is preferable to execute steps S150 to S180 using a redefined noise floor level obtained by adding some margin to the noise floor level when interference between the FMCW radar and some other radar occurs.

### MODIFICATIONS

The present invention may be embodied in several other forms without departing from the spirit thereof. The embodiment described so far is therefore intended to be only illustrative and not restrictive, since the scope of the present invention is defined by the appended claims rather than by the description preceding them. All changes that fall within the metes and bounds of the claims, or equivalents of such metes and bounds, are therefore intended to be embraced by the claims.

What is claimed is:

1. A method for detecting an event of interference in which an incident radio wave received by a radar includes a radio wave which has been transmitted by some other radar and superimposed on a return of a radar wave as having been transmitted by a radar, comprising steps of:
performing frequency analysis on an electric signal to which the radar converts the incident radio wave to obtain a distribution of intensities of frequency components of the electric signal in a frequency domain;
identifying one of the frequency components which has intensity exceeding a predetermined intensity threshold and which is out of a given frequency range in which the return of the radar wave from a target object within the radar range is to fall as an exceptional frequency component;
reducing the intensity of the exceptional frequency component to be smaller than or equal to the predetermined intensity threshold to remove influence of an obstacle located out of the radar range on detecting the event of interference;
calculating a reference value by summing up both the reduced intensity of the exceptional frequency component and the intensities of the frequency components which are other than the exceptional frequency component and are out of the given frequency range; and
determining whether or not the interference is occurring based on the reference value.

2. The method according to claim 1, wherein
the intensity of the exceptional frequency component which intensity exceeds the predetermined intensity threshold is replaced with zero level in intensity to give the reduced intensity of the exceptional frequency component, and
the reference value which is calculated by summing up both the reduced intensity of the exceptional frequency component and the intensities of the frequency components which are other than the exceptional frequency component and are out of the given frequency range is corrected by being multiplied by a factor that is a function of a ratio of a number of the exceptional frequency component to a number of ones of the frequency component which are out of the given frequency range.

3. The method according to claim 1, wherein
the intensity of the exceptional frequency component which intensity exceeds the predetermined intensity threshold is replaced with value of the predetermined intensity threshold to give the reduced intensity of the exceptional frequency component.

4. The method according to claim 1, wherein
the radar is a frequency modulated continuous wave (FMCW) radar that transmits a frequency-modulated radar wave whose frequency changes in time, the radar wave having an upward modulated section during which the frequency of the radar wave increase in time and a downward modulated section during which the frequency of the radar wave decrease in time,
the electric signal includes a first beat signal and a second beat signal which are generated by mixing the incident radio wave received by the radar and the return of the radar wave transmitted from the radar in the upward modulated section and in the downward modulated section, respectively, and
at least one of the first and second beast signals is used to obtain a distribution of intensities of frequency components.

5. The method according to claim 4, wherein
the intensity of the exceptional frequency component is reduced to zero level in intensity,
the reference value is corrected according to a ratio of the number of the exceptional frequency components to the number of ones of the frequency components which are out of the given frequency range, and
the corrected reference value is used to determine whether or not the interference is occurring as the reference value.

6. The method according to claim 1, further comprising steps of:
redefining exceptional frequency components as ones of the frequency components which have distances from one of the frequency components which has intensity exceeding a predetermined intensity threshold and which is out of the given frequency range.

7. A frequency modulated continuous wave (FMCW) radar that detects a target object characteristic including at least one of presence of a target object within a radar range of the radar, a distance between the target object and the radar, and a relative speed of the target object to the radar, comprising:
a transmission signal generator that generates a transmission signal whose frequency is modulated so as to have a upward modulated section during which the frequency of the transmission signal increase in time and a downward modulated section during which the frequency of the transmission signal decrease in time;
a transmission antenna that transmits the transmission signal as a radar wave in direction of the radar range;
a reception antenna unit that receives an incident radio wave received by a radar includes a radio wave which has been transmitted by some other radar and superimposed on a return of a radar wave as having been transmitted by a radar so as to generate a received signal based on the incident radio wave;
a beat signal generator that generates a first and second beat signals with respect to each of the upward modulated section and the downward modulated section, respectively, based on both the transmission signal and the received signal;
an frequency analyzer that performs frequency analysis on the first and second beat signals to obtain a first and a second frequency spectrum characteristics which show distribution of intensities of frequency components of the beat signal in frequency domain with respect to the upward modulated section and the downward modulated section, respectively;
an exceptional frequency component identifying unit that identifies at least one of the frequency components a first and a second frequency spectrum characteristics, the one of the frequency components having intensity exceeding a predetermined intensity threshold and which is out of the given frequency range in which the return of the radar wave from a target object within the radar range is to fall as exceptional frequency component;
a reducing unit that reduces the intensities of the exceptional frequency component to be smaller than or equal to the predetermined intensity threshold to remove influence of an obstacle located out of the radar range on detecting the event of interference;
a reference value calculator that calculates a reference value by summing up both the reduced intensity of the exceptional frequency component and the intensities of the frequency components other than the exceptional frequency component which are other than the exceptional frequency component and are out of the given frequency range; and
an interference detector that detects whether or not the interference is occurring based on the reference value; and
a target object characteristic calculator that calculates the target object characteristic based on the first and second peak frequencies.

8. The radar according to claim 7, wherein
the intensity of the exceptional frequency component which intensity exceeds the predetermined intensity threshold is replaced with zero level in intensity to give the reduced intensity of the exceptional frequency component, and
the reference value which is calculated by summing up both the reduced intensity of the exceptional frequency component and the intensities of the frequency components which are other than the exceptional frequency component and are out of the given frequency range is corrected by being multiplied by a factor that is a function of a ratio of a number of the exceptional frequency component to a number of ones of the frequency component which are out of the given frequency range.

9. The radar according to claim 7, wherein
the intensity of the exceptional frequency component which intensity exceeds the predetermined intensity threshold is replaced with value of the predetermined intensity threshold to give the reduced intensity of the exceptional frequency component.

10. The method according to claim 7, further comprising:
redefining unit that redefines exceptional frequency components as ones of frequency components which have distances from one of the frequency components which has intensity exceeding a predetermined intensity threshold and which is out of the given frequency range.
